(19) United States
(12) Patent Application Publication
(10) Pub. No.: US 2024/0424472 A1
(43) Pub. Date: Dec. 26, 2024

(54) LOW DENSITY ABSORBENT AND CLUMPING COMPOSITE PARTICLE

(71) Applicant: Progressive Planet Solutions Inc., Kamloops (CA)

(72) Inventors: Stephen HARPUR, Salmon Arm (CA); Steve GURNEY, Kamloops (CA); Roger MAH, Calgary (CA); Michael CARRELL, Kamloops (CA); Earl JENSON, Vegreville (CA)

(21) Appl. No.: 18/749,876

(22) Filed: Jun. 21, 2024

Related U.S. Application Data
(60) Provisional application No. 63/522,235, filed on Jun. 21, 2023.

(51) Int. Cl. B01J 20/14; B01J 20/28; B01J 20/30; B01J 20/32

(52) U.S. Cl. CPC B01J 20/14; B01J 20/28004; B01J 20/28016; B01J 20/2803; B01J 20/3035; B01J 20/3078; B01J 20/3204; B01J 20/3223; B01J 20/3236; B01J 20/3293

(57) ABSTRACT

A method of forming a composite particle useful as an animal litter is provided. An absorbent core is formed from an absorbent material. A coating composition is formed by combining a coating material and a binder and heat treating the combined coating material and binder and the resulting coating composition is coated on the absorbent core.

### CROSS-REFERENCE TO RELATED APPLICATIONS

This application claims priority to, and the benefit of, U.S. provisional patent application No. 63/522,235 filed 21 Jun. 2023, the entirety of which is incorporated by reference herein.

### TECHNICAL FIELD

Some embodiments relate to clumping absorbent particles useful for example as animal litter. Some embodiments relate to clumping absorbent particles that are low density. Some embodiments relate to methods of making and using clumping absorbent particles.

### BACKGROUND

Absorbent materials such as clay, diatomaceous earth, zeolite and others are used for a variety of different purposes. One common use of such materials is as absorbents in animal litter, for example cat litter, which is frequently used to absorb urine when animals are kept in indoor settings.

There is a general desire for absorbent materials that have a high degree of absorbency (i.e. which can absorb a large volume of liquid) but which are relatively lightweight (e.g. having a low density), for example to minimize shipping costs and inconvenience to consumers purchasing such materials. There can further be benefits to providing absorbent materials that can absorb and/or neutralize odors associated with animal urine. There can be further benefits to using absorbent particles that clump together when wetted, to facilitate easy removal of soiled litter from as-yet unused litter. There can be further benefits to using absorbent particles that form even clumps without allowing moisture to penetrate a significant distance downwardly into the litter.

The foregoing examples of the related art and limitations related thereto are intended to be illustrative and not exclusive. Other limitations of the related art will become apparent to those of skill in the art upon a reading of the specification and a study of the drawings.

### SUMMARY

In some aspects, a method of making a composite particle useful for example as animal litter is provided. An absorbent core is formed from an absorbent material. A coating composition is formed by combining a coating material and a binder and heat treating the combined coating material and binder, and then using the prepared coating composition to coat the absorbent core.

In some aspects, the absorbent material is an aluminosilicate material such as diatomaceous earth. In some aspects, the absorbent material is diatomaceous earth fines. In some aspects, the absorbent core is formed through compaction such as by using a roller compactor to produce the absorbent core from the absorbent material. In some aspects, the absorbent material is adjusted to a moisture content of between about 8% and about 12% prior to being compacted to form the absorbent core. In some aspects, the absorbent cores are formed to have a range of particle diameters between about 1.2 mm and about 1.7 mm.

In some aspects, forming the coating composition comprises first forming an aqueous solution of the binder. In some aspects, the binder is dissolved in warm water, for example having a temperature between about 40° C. and about 70° C., and then the coating material is mixed with the aqueous binder solution. In some aspects, the binder is a carbohydrate binder. In some aspects, the binder is a polysaccharide binder. In some aspects, the polysaccharide binder is carboxymethylcellulose (CMC), a starch, a modified starch, a dextrin or a modified dextrin. In some aspects, the polysaccharide binder is carboxymethylcellulose (CMC). In some aspects, the coating material is an aluminosilicate such as bentonite. In some aspects, the coating material is bentonite fines.

In some aspects, the coating composition is heat treated after initial formation. In some aspects, the heat treating includes drying the coating composition at a temperature of between about 90° C. and about 115° C. for a suitable period, for example between about 4 hours and about 24 hours. In some aspects, the coating composition is size reduced after the heat treating to form particles suitable for use as a coating.

In some aspects, the coating composition is coated on the absorbent core in a seasoning drum, a coating drum, or the like. In some aspects, water is added during the coating process to help the coating composition adhere to the absorbent core. In some aspects, a further binder is incorporated into the water that is added during the process, for example a dilute solution of carboxymethylcellulose. In some aspects, the amount of water added during the coating process is between about 20% to about 30% relative to a total final weight of the composite particles after coating. In some aspects, the coated particles have a range of diameters of between about 1.5 to about 2.0 mm after coating.

In some aspects, a composite particle produced by the method has, on a dry matter basis, between about 50% to about 60% by weight of the absorbent material, between about 30% to about 40% by weight of the coating material, and between about 8% to about 12% by weight of the binder. In some aspects, a ratio of the binder to the coating material used to produce the clumping coating is in the range of about 1:5 to about 1:10 by weight on a dry matter basis. In some aspects, a composite particle made by any of the foregoing methods is provided. Other features and aspects will become apparent on review of the following specification and drawings.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 illustrates an exemplary composite particle according to one embodiment.

FIG. 2 illustrates an example embodiment of a method for making an absorbent core for a composite particle according to one example embodiment.

FIG. 3 illustrates an example embodiment of a method for making a clumping coating for a composite particle according to one example embodiment.

FIG. 4 illustrates an example embodiment of a method for applying the clumping coating to the absorbent core to form a composite particle according to one example embodiment.

FIG. 5 illustrates an exemplary composite particle according to a second embodiment.

FIG. 6 illustrates an example embodiment of a method for making an absorbent core for a composite particle according to a second example embodiment.

FIG. 7 illustrates an example embodiment of a method for making a clumping coating for a composite particle according to a second example embodiment.

FIG. 8 illustrates an example embodiment of a method for applying the clumping coating to the absorbent core to form a composite particle according to a second example embodiment.

FIG. 9 shows the difference between bentonite powder alone and bentonite powder mixed with heat-treated carboxymethylcellulose according to an example embodiment with respect to liquid absorption.

### DESCRIPTION

Throughout the following description specific details are set forth to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

As used in this specification, the term “about” means that some deviation, e.g. ±5% from the recited value, is permissible.

The inventors have discovered that a two-component or composite particle can be advantageous to produce a lightweight animal litter product, i.e. a litter having a lower density than a litter made from only a single component, since the core of the two-component particle does not need to exhibit clumping properties which can be provided by the outer coating. Thus, the core material may be able to be a lightweight material or a low cost or residual material, enabling production of a composite particle having the desired size range with clumping properties provided by the outer coating. Optionally an additional odour absorbing material can be incorporated into the core of the composite particle to improve overall qualities of the litter such as odour absorption.

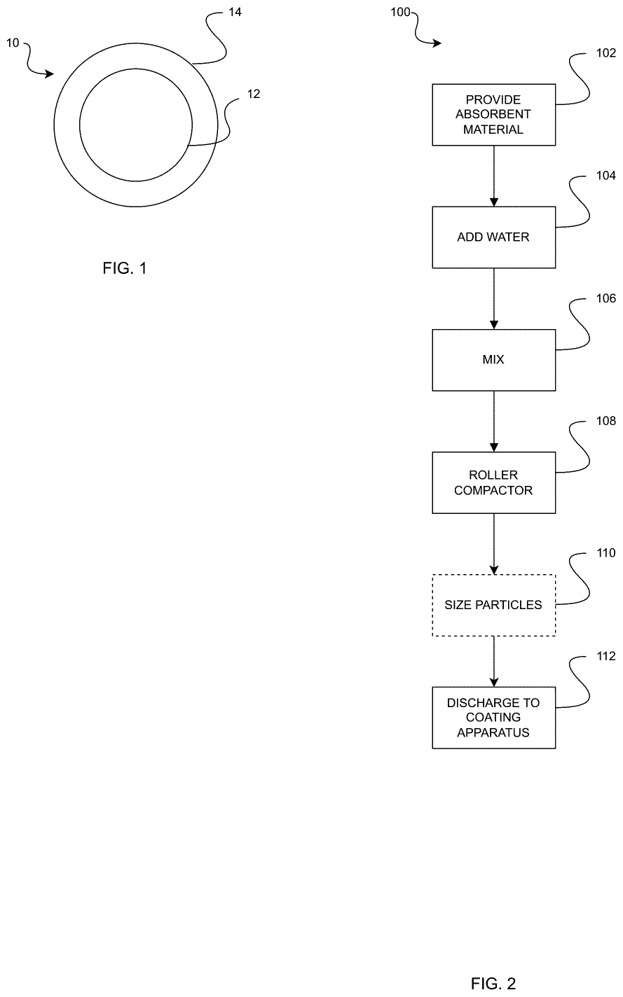

As illustrated in FIG. 1, example embodiments of composite particles 10 have an absorbent core 12 having an outer clumping coating 14, the composition of each of which is described in greater detail below. In a first example embodiment, an absorbent core 12 made from material that has been moistened with water and then compressed in an apparatus such as a roller compactor to form a seed granule may be used. In a second example embodiment, an absorbent core made from a material that has been moistened with a significant amount of water and then then agglomerated in the presence of a binder in an apparatus such as a pin mixer to form a seed granule may be used.

### Absorbent Core of First Embodiment

In one example embodiment, the composite particles 10 have an absorbent core 12 made from an absorbent material that has been compressed using water to help bind the absorbent material to form a seed granule. Optionally other materials may be included in the absorbent core, such as binders, additives for improving odour absorption properties, or the like. Embodiments having an absorbent core 12 made from a material that has been compressed using water to help bind the absorbent material to form a seed granule may be used for example where a method of production is desired that uses a relatively low moisture input.

In some embodiments, the absorbent material is aluminosilicates or hydrous aluminum silicates, phyllosilicates, tectosilicates, nesosilicates/orthosilicates, or siliceous rocks, including for example clay, volcanic clays, zeolites, bentonite, diatomaceous earth, montmorillonite, Fuller's earth, silicates, attapulgite, smectites, kaolinite, hormites, sepiolite, halloysite, metakaolin, hectorite, vermiculite, fly ash, muscovite, biotite, chlorite, hallyosite, illite, quartz, feldspar, micas, andalusite, kyanite, sillimanite, leucite, faujasite, analcime, nepheline, prehnite, pumice, gypsum, alumina, perlite, calcite, dolomite, or the like. In some embodiments, the absorbent material is diatomaceous earth. In some embodiments, the absorbent material is zeolite. In some embodiments, the absorbent material is a mixture of diatomaceous earth and bentonite. In some embodiments, the absorbent material is diatomaceous earth fines.

In some embodiments, the absorbent material is present in an amount of about 35% and about 70% by weight on a dry matter basis of the weight of composite particle 10, including any value therebetween, e.g. 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68 or 69% by weight on a dry matter basis of the weight of composite particle 10. In some embodiments, the absorbent material is present in an amount of about 50% to about 60% by weight on a dry matter basis of the weight of composite particle 10. In one specific example embodiment the absorbent material is present in an amount of approximately 55% by weight on a dry matter basis of the weight of composite particle 10.

In some embodiments, the absorbent material is provided as a fine powder. In some embodiments, the absorbent material fine powder has a diameter of less than about 850 microns, including less than 800, 750, 700, 650, 600, 550, 500, 450, 400, 350, 300, 250, 200, 150 or 100 microns. In some embodiments, the absorbent material is a fine powder that has a diameter of between about 100 and about 850 microns, including any value or subrange therebetween.

In some embodiments, water is added to the absorbent material used to make absorbent core 12, and is present in an amount sufficient to provide approximately a 8% to 12% moisture content for the material being used to prepare absorbent core 12. In one example embodiment, water is added to the absorbent material to an approximate moisture content of about 10% to form absorbent core 12. In one example embodiment, the core material has approximately a 6% moisture content as supplied and then sufficient water is added to bring the overall moisture content of the core material to approximately 10% prior to forming the particle for absorbent core 12.

With reference to FIG. 2, a method 100 of making an absorbent core for a composite particle according to an example embodiment is illustrated. At 102, the absorbent material, e.g. finely powdered diatomaceous earth, is provided. At 104, water is added to the absorbent material. At 106, the water and the absorbent material are mixed in any suitable manner, for example in a rotary batch mixer, a rotary continuous mixer, or the like.

At 108, an apparatus suitable for compacting the absorbent material, for example a roller compactor, is used to produce small seed granules of the absorbent material as the absorbent core 12. In some embodiments, the seed granules have a size in the range of about 1 mm to about 2 mm in diameter, including any value or subrange therebetween, e.g. about 1.1, 1.2, 1.3, 1.4, 1.5, 1.6, 1.7, 1.8 or 1.9 mm in diameter. The person skilled in the art can control the size of granules that are produced by a roller compactor for example by adjusting the screen size and/or the die size used within the apparatus. For example, selection of the appropriate die size can assist in forming granules of a desired size range, and then any granules that are either oversize or undersize are screened out and removed. In some embodiments, after passing through the roller compactor, the absorbent core 12 has a moisture content by weight in the range of about 8% to about 12%, including any value or subrange therebetween, e.g. about 9, 10 or 11% moisture content by weight. In one example embodiment, the absorbent core 12 has a moisture content of approximately 10% by weight after being formed using a roller compactor.

At 110, the seed granules produced at 108 are optionally sized in any suitable manner to provide seed granules having a desired range of diameters. For example, in one embodiment, the seed granules produced at 108 are screened so that the selected seed granules have a diameter in the range of about 1.2 mm to about 1.7 mm, including any value or subrange therebetween.

At 112, the seed granules produced by the roller compactor at 108 are discharged (optionally after size selection step 110), for example into a coating apparatus, for example a pan granulator, a seasoning drum, a coating drum or the like, to be coated with outer clumping coating 14.

### Outer Clumping Coating of First Embodiment

The coating powder for preparing outer clumping coating 14 is prepared from a material that will cause the composite particles to clump together when exposed to moisture. In some embodiments, the coating powder contains fine bentonite powder as a coating material that in combination with a binder acts as a clumping agent. In some embodiments, the coating powder contains an absorbent coating material and the binder acts as a clumping agent.

In some embodiments, the coating material is aluminosilicates or hydrous aluminum silicates, phyllosilicates, tectosilicates, nesosilicates/orthosilicates, or siliceous rocks, including for example clay, volcanic clays, zeolites, bentonite, diatomaceous earth, montmorillonite, Fuller's earth, silicates, attapulgite, smectites, kaolinite, hormites, sepiolite, halloysite, metakaolin, hectorite, vermiculite, fly ash, muscovite, biotite, chlorite, hallyosite, illite, quartz, feldspar, micas, andalusite, kyanite, sillimanite, leucite, faujasite, analcime, nepheline, prehnite, pumice, gypsum, alumina, perlite, calcite, dolomite, or the like In some embodiments, the coating material is a mixture of diatomaceous earth and bentonite. In some embodiments, the coating material is bentonite. In some embodiments, the coating material is bentonite fines.

In some embodiments, the coating material is provided as a fine powder. In some embodiments, the coating material is a fine powder that has a diameter of less than about 850 microns, including less than 800, 750, 700, 650, 600, 550, 500, 450, 400, 350, 300, 250, 200, 150 or 100 microns. In some embodiments, the coating material is a fine powder that has a diameter of between about 100 and about 850 microns, including any value or subrange therebetween.

In some embodiments, the coating powder, including any binder contained therein as well as the coating material, is present in an amount of between about 30% and about 65% by weight of the dry matter of composite particle 10, including any value or subrange therebetween, e.g. about 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63 or 64% by weight on a dry matter basis of the weight of composite particle 10. In one specific example embodiment, the coating powder is present in an amount of approximately 45% by weight on a dry matter basis of the weight of composite particle 10. Correspondingly, the coating material is present in an amount of between about 15% to about 60% by weight on a dry matter basis of the weight of composite particle 10, including any value or subrange therebetween, e.g. about 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58 or 59% by weight on a dry matter basis of the weight of composite particle 10. In one example embodiment, the coating material is present in an amount of between about 30% and about 40% by weight of the composite particle 10. In one example embodiment, the coating material is present in an amount of about 35% by weight of the composite particle 10.

In some embodiments, the binder is a polysaccharide such as carboxymethyl cellulose (CMC), a starch, a modified starch, a dextrin, a modified dextrin, or the like. In some embodiments, the binder is a high viscosity CMC such as a CMC having a viscosity of a 1% solution in water at 25° C. of between about 1500-3000 centipoise (cP). In some embodiments, the binder is a low viscosity CMC such as a CMC having a viscosity of a 1% solution in water at 25° C. of between about 50-200 cP, including any value or subrange therebetween e.g. 75, 100, 125, 150, or 175 cP. In some embodiments, the binder is a medium viscosity CMC such as a CMC having a viscosity of a 1% solution in water of between about 400-800 cP, including any value or subrange therebetween e.g. 450, 500, 550, 600, 650, 700 or 750 cP. In some embodiments, the binder is a medium-low viscosity CMC such as a CMC having a viscosity of between about 200-400 cP, including any value or subrange therebetween e.g. 225, 250, 275, 300, 325, 350, or 375 cP. In some embodiments, the binder is a medium-low viscosity CMC. Without being bound by theory, high viscosity CMC can be difficult to work with due to difficulty dissolving the material and combining the dissolved CMC with the coating material, and use of medium or low viscosity CMC may enable better incorporation of the CMC into the coating material and therefore provide better clumping properties. In some embodiments, the starch is a modified corn starch or a dextrin derived from corn starch. In some embodiments, the binder is a binder that retains and exhibits adhesive qualities after formulation in order to facilitate clumping of composite particles 10 upon their exposure to moisture. In some embodiments, a plurality of different binders can be used, for example a combination of CMC and one or more starches in some example embodiments.

In some embodiments, the carbohydrate binder is a polysaccharide binder such as a starch, a dextrin, a chemically modified starch, a chemically modified dextrin, or the like. For example, in some embodiments, the chemically modified starch or dextrin can be a viscosity-modified waxy corn starch such as ICB 3200, a dent acid-modified corn starch such as ANCHOR® LR, a dextrinized starch-based binder made from cornstarch such as STADEX®, a hydroxyethylated starch such as ETHYLEX®, a waxy acid modified starch such as STA-TAPE™, a dent unmodified starch such as Pearl C Starch, a modified corn starch such as STARAMIC™, a starch-based polymer such as STARPOL®, a cationic potato starch, or the like.

In some embodiments, the binder is present in an amount of between about 5% and about 15% by weight on a dry matter basis of the weight of composite particle 10, including any amount therebetween, e.g. about 5.5, 6.0, 6.5, 7.0, 7.5, 8.0, 8.5, 9.0, 9.5, 10.0, 10.5, 11.0, 11.5, 12.0, 12.5, 13.0, 13.5, 14.0 or 14.5% by weight on a dry matter basis of the weight of composite particle 10. In some embodiments, the binder is present in an amount of between about 8% and about 12% by weight on a dry matter basis of the weight of composite particle 10. In one example embodiment, the binder is present in an amount of between about 8% to about 9% by weight on a dry matter basis of the weight of composite particle 10.

In some embodiments, the coating material and the binder are combined and are subjected to a heat treatment e.g. during drying, as described in more detail below. Without being bound by theory, it is believed that such heat treatment can alter the manner in which the binder interacts with the coating material, thereby improving the water absorptive properties of the clumping coating 14.

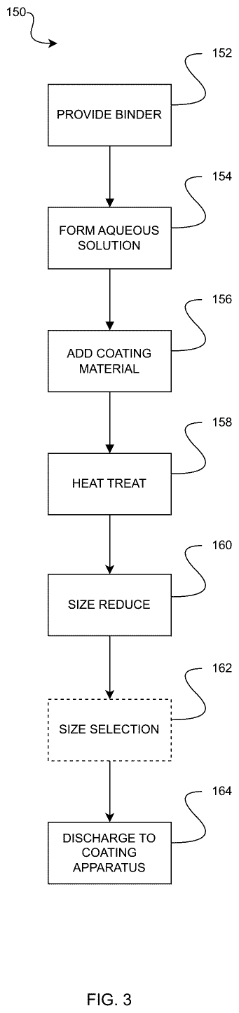

With reference to FIG. 3 which illustrates a method 150 of preparing a clumping coating according to one example embodiment, the binder is supplied at 152 and an aqueous mixture of the binder is prepared at 154. In some embodiments in which the binder is carboxymethylcellulose, the aqueous solution of the binder is prepared at 154 by warming water to a temperature in the range of about 40° C. to about 70° C., including any value or subrange therebetween, e.g. about 45, 50, 55, 60, or 65° C. In some embodiments, a concentration of carboxymethylcellulose in the warmed water is in the range of about 40 g/L to about 50 g/L, including any value or subrange therebetween, e.g. about 41, 42, 43, 44, 45, 46, 47, 48 or 49 g/L. The inventors have found that a solution of carboxymethylcellulose in warmed water at a concentration of about 45 g/L works well for dissolving the binder and facilitating the subsequent mixing step with the coating material. In alternative embodiments using a lower concentration of binder, cooler temperatures (e.g. ambient temperature) may be used. A suitable mixer, for example a high shear mixer or the like, is used to create the aqueous solution of the binder.

At 156, the coating material is mixed with the aqueous binder mixture. For example, in embodiments in which the coating material is bentonite and the binder is carboxymethylcellulose, for small batch production a hand blender or hand mixer is used at 156 to mix the coating material with the binder. For large scale production, any suitable mixing apparatus such as a slow speed bladed mixer, a ribbon mixer or the like may be used to combine the coating material with the aqueous binder mixture. In some embodiments, the binder is mixed with the coating material in a weight ratio of about 1:5 to about 1:10 on a dry matter basis, including any subrange therebetween, e.g. about 1:6 to about 1:10, about 1:7 to about 1:10, about 1:8 to about 1:10, about 1:9 to about 1:10, about 1:5, or the like. In alternative embodiments, other ratios of binder might be used if a larger amount of clumping coating is applied relative to the amount of absorbent core particles used, although this may result in the formation of a composite particle with a higher density overall since the absorbent core is generally made from a material having a lower density than the coating material.

At 158, the combined coating material and binder are subjected to a heat treatment to dry the material in preparation for forming the coating powder. In some embodiments, the combined coating material and binder are dried at a temperature of between about 90° C. and 115° C., including any value or subrange therebetween e.g. 92, 94, 96, 98, 100, 102, 104, 106, 108, 110, 112 or 114° C. until the material is fully dry. In some embodiments, the combined coating material and binder are dried at a temperature of between about 98° C. and 115° C. The time required to dry the material may vary depending on the drying apparatus used (e.g. vacuum drying, tumbling drying, or stationary drying), and e.g. if vacuum drying is used then a correspondingly lower temperature could be used if desired (e.g. between about 80° C. and about 105° C. or any temperature or subrange therebetween). In some embodiments, drying is carried out in a stationary dryer, e.g. for a period of between about 4 hours to about 24 hours, including any value or subrange therebetween, e.g. 5, 6, 7, 8, 9, 10, 11, 12, 13, 14, 15, 16, 17, 18, 19, 20, 21, 22 or 23 hours. In other embodiments, a tumbling dryer that breaks up material as it forms a crust or a vacuum drying apparatus may be used and a shorter drying time may be required. Without being bound by theory, until the material has fully dried, the temperature within the damp material will tend to remain at approximately 100° C. In some embodiments, at 158, the combined coating material and binder are dried to a final moisture content of between about 2% and about 7%, including any value or subrange therebetween e.g. about 3, 4, 5 or 6%.

In some embodiments, to facilitate preparation of the combined coating material and binder in its wet state for drying, the wet material is combined with previously produced dry coating material and binder to reduce the moisture content of the combined material to a point where the material can be extruded (e.g. approximately 25% moisture content), so that pellets of the combined material can be formed by extrusion. The extruded pellets can then be supplied to a dryer for drying as described above.

At 160, the resultant dried cake is broken apart or otherwise rendered suitable for use as a coating. For example, in some embodiments the dried cake can be size reduced with a mortar and pestle or appropriate crushing or grinding apparatus such as a ball mill, roller miller, hammer mill, cone crusher, or the like to form a powder suitable for coating. In some embodiments, at 162 a size selection step is optionally performed, e.g. screening, to ensure that only particles of the prepared coating material having a desired size range are used for coating. In some embodiments, the coating has a particle size of less than about 750 μm, e.g. between about 650 and 750 μm, including any value or subrange therebetween e.g. about 675, 700 or 725 μm or less. At 164, the prepared coating is provided to a suitable coating apparatus as described in more detail below.

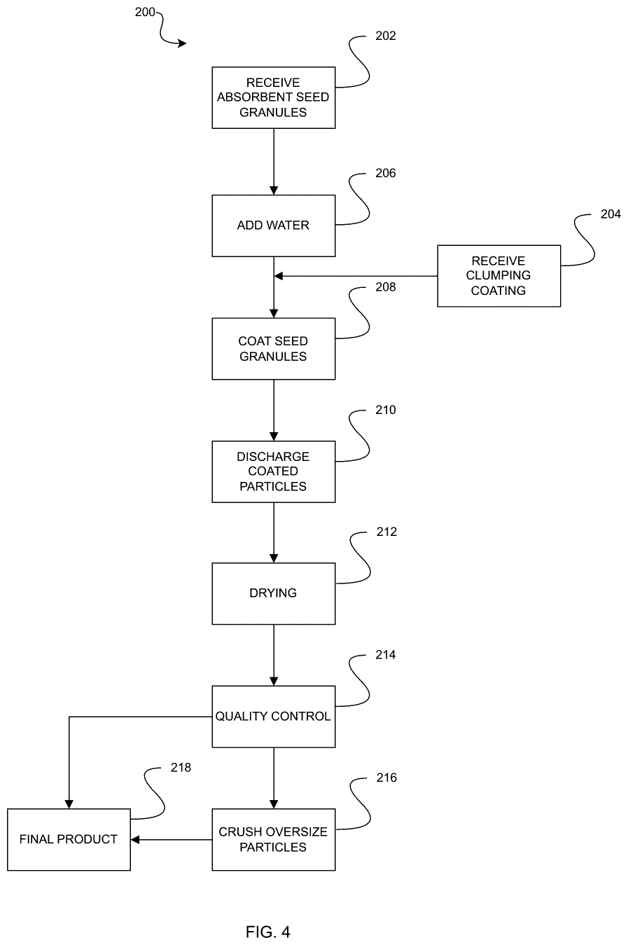

To apply the outer clumping coating to the absorbent core, as illustrated in FIG. 4 which shows an example embodiment of a method 200 for applying the clumping coating to the absorbent core to form a composite particle according to one example embodiment, at 202 the seed granules of the absorbent core discharged at 112 are received in a suitable apparatus for applying the clumping coating, for example a pan granulator, a disc pelletizer, a drum coater, a seasoning drum, or the like. At 204, the clumping coating discharged at 164 is also received by the apparatus for applying the clumping coating.

In one example embodiment, a seasoning drum or coating drum is used as the coating apparatus in method 200 to coat the absorbent core with the clumping coating at 208. At 206, water is added as an adhesion agent during the coating of absorbent core 12, to help the prepared clumping coating 14 adhere to the core. In some embodiments, the amount of water added to the dry material to promote coating is in the range of about 20% to about 30% of the total mass of the composite particle after water addition, including any value or subrange therebetween, e.g. about 21, 22, 23, 24, 25, 26, 27, 28 or 29% by weight water to the total mass of the composite particle after water addition. As an example, approximately 50 grams of absorbent core 12 may be coated with approximately 40 grams of clumping coating 14, and then approximately 25 to 35 grams of water may be added to help adhere the clumping coating 14 to the absorbent core 12.

In the coating drum during coating step 208, the absorbent core 12 is tumbled and rolled while the coating powder is slowly added along with a water spray that acts as an adhesive to adhere the coating powder to the absorbent core 12 to form the clumping coating 14. In one specific example embodiment, 50 grams of absorbent core 12 is combined with approximately 40 grams of coating powder and approximately 20 to 35 grams of water to form clumping coating 14.

A coating drum applies a relatively uniform amount of coating to each absorbent core seed granule, so that the size distribution of the finished product will be slightly larger than, but with a similar variation in size ranges of the particles, the absorbent core seed granules. For example, in one embodiment, the coating drum is configured to apply approximately 0.3 mm of the clumping coating to each absorbent core particle, so that the overall range of particle sizes for the finished product is between about 1.5 mm to about 2.0 mm. Without being bound by theory, it is believed that a range of particle sizes for the finished composite particles may increase the packing of the particles together and provide overall better clumping performance than would be the case for a product containing finished composite particles all having approximately the same particle size.

In some embodiments, one or more additional binders can be added during coating step 208, for example an additional carbohydrate binder such as CMC, a starch, a dextrin, a chemically modified starch, a chemically modified dextrin, or the like. For example, in some embodiments, the chemically modified starch or dextrin can be a viscosity-modified waxy corn starch such as ICB 3200, a dent acid-modified corn starch such as ANCHOR® LR, a dextrinized starch-based binder made from cornstarch such as STADEX®, a hydroxyethylated starch such as ETHYLEX®, a waxy acid modified starch such as STA-TAPE™, a dent unmodified starch such as Pearl C Starch, a modified corn starch such as STARAMIC™, a starch-based polymer such as STARPOL®, a cationic potato starch, or the like.

Coated particles are then discharged from the coating drum at 210 and are conveyed to a drying apparatus at 212 for drying.

In one alternative example embodiment, a pan granulator is used in method 200 to coat the absorbent core with the clumping coating. A pan granulator can be configured to discharge particles having a desired size, so that smaller absorbent core seed granules will have more coating applied than larger absorbent core seed granules, but the discharged final product will have a relatively consistent overall particle size. In some embodiments, the pan granulator is set up with a secondary powder feed for applying the clumping coating at 204, and a water spray system to add water at 206, to increase the moisture content and adhesion and cause agglomeration of the dry clumping coating onto the seed granules of the absorbent core as the dry clumping coating is applied. In one particular example embodiment, the water spray system is set up to spray granules in the upper front quadrant of the pan granulator, and the addition of the clumping coating is carried out only in the lower back quadrant of the pan granulator, so that the clumping coating powder itself does not agglomerate but rather coats the existing seed granules of the absorbent core at 208. In some embodiments, the water spray at 206 is applied at or near the top of the path of travel of the seed granules, and the clumping coating powder at 204 is added at or near the bottom of the path of travel of the seed granules.

The process conducted in method 200 is a coating process and does not result in the formation of any significant number of new granules formed of just the clumping coating. The operation of a pan granulator to coat existing seed particles would be known to one skilled in the art, as for example described in A. A. Lipin and A. G. Lipin, “Particle coating with composite shell in a pan granulator”, Particulate Science and Technology, 40(1): pp. 123-130, published online: 24 May 2021, doi.org/10.1080/02726351.2021.1927272.

In one example embodiment using a pan granulator to carry out the coating of the absorbent core, the coating process conducted in method 200 utilizes a powder addition at a mass rate at 202 of approximately 80% dry coating powder mass to the mass rate of wet core seed granules being supplied at 204. At 206, a spray of water at a mass rate of approximately 35% of the coating powder mass addition is continuously sprayed on the formed granules during the coating process. As a specific example, if 100 kg per hour of wet seed granules (i.e. absorbent core 12) are passing through the pan granulator, 80 kg of coating powder per hour is applied for coating along with a water spray of 28 kg per hour to facilitate the powder adhesion and the coating process.

In some embodiments, the pan granulator is set up so that coated composite particles having a diameter of between about 1.5 and about 2.0 mm, including any value therebetween, e.g. 1.6, 1.7, 1.8 or 1.9 mm, exit the process at 210 and are conveyed to a drying apparatus for drying at 212.

In some embodiments, any suitable drying apparatus can be used at step 212, for example a drum dryer, belt dryer, fluidized bed dryer, or the like. In some embodiments, a maximum temperature at which the produced composite particles are dried at step 212 is less than about 105° C. In some embodiments, the composite particles are dried to a moisture content of about 7% water by weight or lower, e.g. about 6.5%, 6% or 5.5% moisture content. Other drying temperatures and final moisture contents could be used if desired, balancing considerations such as the maximum temperature to which any of the components of the composite particles, particularly any binder(s) used, can be exposed, and the increased energy that may be required to reach lower moisture contents.

In some embodiments, a quality control step 214 is applied after drying step 212. For example, in some embodiments, the composite particles are screened after drying to ensure that composite particles having larger than a predetermined size are not present in the final product. For example, in some embodiments, after screening, any particles having larger than the desired predetermined size are transferred to a roller crusher system at 216 and fractured, so that the fractured granules can be added to the final product at 218. In some embodiments, an ideal size range for the final product is between about 1.5 mm to about 2.0 mm in diameter, including any size or subrange therebetween, e.g. about 1.6, 1.7, 1.8, or 1.9 mm in diameter.

### Absorbent Core—Second Embodiment

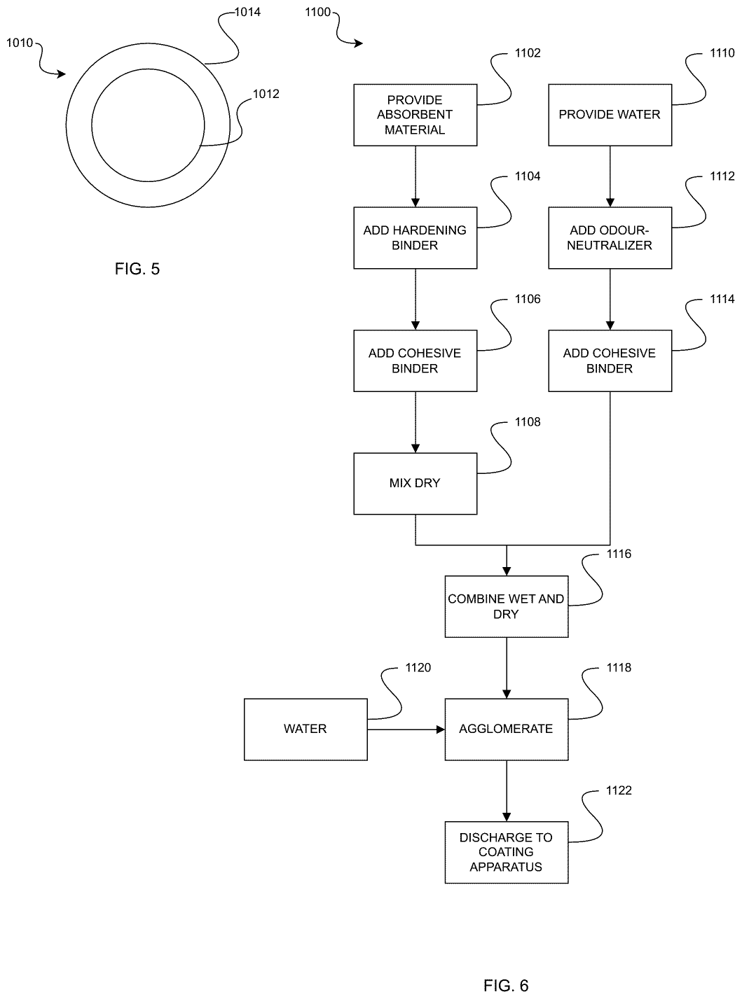

In one example embodiment, as illustrated in FIG. 5, the composite particles 1010 have an absorbent core 1012 made from an absorbent material, a cohesive binder, and a core hardening binder. In some embodiments, the absorbent core 1012 of the composite particles 1010 further contains an odour-neutralizing agent. In some embodiments, incorporating the odour-neutralizing agent in the absorbent core 1012 prevents the odour-neutralizing agent from interacting to a significant extent with the components of the outer clumping coating 1014 and potentially interfering with the properties of the outer clumping coating 1014 that facilitate clumping. In some embodiments, absorbent core 1012 is made using an agglomeration production process such as mixing in a pin mixer that requires a larger amount of water to be used in the formation of absorbent core 1012 than does absorbent core 12, which is made by a compaction production process such as a roller compactor that requires the use of less water during the formation of absorbent core 12. As an example, forming the absorbent core 12 from an absorbent material such as diatomaceous earth by compaction may require adjusting the moisture content of the diatomaceous earth to about 7% to about 15% by weight (including any value or subrange therebetween, e.g. about 8, 9, 10, 11, 12, 13 or 14% by weight), whereas forming an absorbent core 1012 from an absorbent material such as diatomaceous earth using an agglomeration process may require the addition of up to about 45% to about 55% as well as a binder to produce particles suitable for use as absorbent core 1012 (including any value or subrange therebetween, e.g. about 46, 47, 48, 49, 50, 51, 52, 53 or 55% by weight).

Without being bound by theory, the use of a process incorporating a higher degree of moisture during preparation of the absorbent core 1012 may enable the incorporation of an odor-neutralizing agent such as an acid into the absorbent core 1012 while avoiding possible interference between the odor-neutralizing agent and the clumping properties of the clumping coating 1014; for example, it is believed that the higher level of moisture present during the agglomeration process to produce absorbent core 1012 may assist in embedding the odor neutralizing agent within the absorbent material, so that interference between the odor neutralizing agent and the clumping coating is less likely to occur.

In some embodiments, the absorbent material is aluminosilicates or hydrous aluminum silicates, phyllosilicates, tectosilicates, nesosilicates/orthosilicates, or siliceous rocks, including for example clay, volcanic clays, zeolites, bentonite, diatomaceous earth, montmorillonite, Fuller's earth, silicates, attapulgite, smectites, kaolinite, hormites, sepiolite, halloysite, metakaolin, hectorite, vermiculite, fly ash, muscovite, biotite, chlorite, hallyosite, illite, quartz, feldspar, micas, andalusite, kyanite, sillimanite, leucite, faujasite, analcime, nepheline, prehnite, pumice, gypsum, alumina, perlite, calcite, dolomite, or the like In some embodiments, the absorbent material is diatomaceous earth. In some embodiments, the absorbent material is zeolite. In some embodiments, the absorbent material is a mixture of diatomaceous earth and bentonite. In some embodiments, the absorbent material is diatomaceous earth fines.

In some embodiments, the cohesive binder is a thickener or a viscosity modifier such as cornstarch, pea starch, or microcrystalline cellulose (MCC). In some embodiments, the cohesive binder is a carbohydrate binder. In some embodiments, the cohesive binder is a polysaccharide binder. In some embodiments, the cohesive binder is a starch. In some embodiments, the cohesive binder is a cellulose. In some embodiments, the cohesive binder is a natural binder.

In some embodiments, the core hardening binder is a hardening agent such as powdered corn syrup or carboxymethyl cellulose (CMC).

In some embodiments, the odour-neutralizing agent is an acid. In some embodiments, the odour-neutralizing agent is an organic acid. In some embodiments, the odour-neutralizing agent is an organic acid having a pH at a concentration of 0.1 N in the range of between about 2 and about 3, including any value therebetween, e.g. a pH at a concentration of 0.1 N of 2.1, 2.2, 2.3, 2.4, 2.5, 2.6, 2.7, 2.8 or 2.9. In some embodiments, the odour-neutralizing agent is one or more of (pH of acid at 0.1 N listed in parentheses) citric acid (2.2), tartaric acid (2.2), malic acid (2.2), formic acid (2.3), lactic acid (2.4), succinic acid (2.7), acetic acid (2.9), or propionic acid (2.9). In one example embodiment, the odour-neutralizing agent is citric acid. In some embodiments, the odour-neutralizing agent is certified for organic use, for example by the Organic Materials Review Institute (OMRI) or other similar certification body.

Without being bound by theory, it is believed that the addition of an acid to absorbent core 1012 can help to neutralize odors by neutralizing ammonia (NH₄⁺), e.g. from animal urine, to its amino salt. Further without being bound by theory, it is believed that in embodiments in which the odour-neutralizing agent is an acid, the acid should remain segregated from the clumping binder in the clumping coating 1014, as the inventors have determined that exposure to acid can impair the clumping ability of the clumping binder if the acid and the clumping binder are permitted to mix directly. Hence a composite particle wherein the odour-neutralizing agent is contained within absorbent core 1012 while the clumping binder is provided in clumping coating 1014 has been found to provide good odour neutralization while still maintaining efficacy of the clumping coating 1014.

In some embodiments, the absorbent material is present in an amount of about 30% and about 60% by weight on a dry matter basis of the weight of composite particle 1010, including any value therebetween, e.g. 31, 32, 33, 34, 35, 36, 37, 38, 39, 40, 41, 42, 43, 44, 45, 46, 47, 48, 49, 50, 51, 52, 53, 54, 55, 56, 57, 58 or 59% by weight on a dry matter basis of the weight of composite particle 1010.

In some embodiments, the absorbent material is provided as a fine powder. In some embodiments, the absorbent material fine powder has a diameter of less than about 850 microns, including less than 800, 750, 700, 650, 600, 550, 500, 450, 400, 350, 300, 250, 200, 150 or 100 microns. In some embodiments, the absorbent material is a fine powder that has a diameter of between about 100 and about 850 microns, including any value or subrange therebetween.

In some embodiments, the cohesive binder is present in an amount of between about 0.5% to about 4% by weight of the total weight of the two-component particle 1010 on a dry matter basis, including any value therebetween such as 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8 or 3.9% by weight of the total weight of the composite particle 1010 on a dry matter basis.

In some embodiments, the core hardening binder is present in an amount of between about 1% and about 8% by weight of the total weight of the two-component particle 1010 on a dry matter basis, including any value therebetween such as 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, 7.0, 7.2, 7.4, 7.6 or 7.8% by weight of the total weight of the composite particle 1010 on a dry matter basis.

In some embodiments, the odour-neutralizing agent is present in an amount of between about 1 and about 10% by weight of the total weight of the composite particle 1010 on a dry matter basis, including any value therebetween such as 1.5, 2.0, 2.5, 3.0, 3.5, 4.0, 4.5, 5.0, 5.5, 6.0, 6.5, 7.0, 7.5, 8.0, 8.5, 9.0 or 9.5% by weight of the total weight of the composite particle 1010 on a dry matter basis.

With reference to FIG. 6, a method 1100 of making an absorbent core for a composite particle according to an example embodiment is illustrated. At 1102, the absorbent material, e.g. finely powdered diatomaceous earth, is provided. At 1104, the core hardening binder, for example carboxymethylcellulose (CMC), is added to the absorbent material. At 1106, the cohesive binder, for example cornstarch, is added to the absorbent material. At 1108, the absorbent material, the cohesive binder that is provided in dry form and the core hardening binder are mixed dry in any suitable manner, for example a rotary batch mixer such as a Rollo-Mixer™.

At 1110, a suitable volume of water is provided and the odour-neutralizer, for example citric acid, is added to the water at 1112. A second portion of the cohesive binder, for example pre-gelatinized corn starch, may be added to the water at 1114 and mixed in any suitable manner in embodiments where at least a portion of the cohesive binder is to be combined in an aqueous solution rather than as a dry ingredient. Without being bound by theory, the cohesive binder such as pre-gelatinized corn starch can be used to adjust the viscosity of the aqueous solution to be added to form the absorbent core 1012, and adjustment of the viscosity as aforesaid can be used to help control the particle size of the resultant absorbent core 1012.

At 1116, the aqueous solution is combined with the dry ingredients for example in the rotary batch mixer, and combined to yield a slightly moist, non-dusty powder mix. This non-dusty powder mix is fed to an agglomeration apparatus such as a pin mixer at 1118 and additional water is supplied to the agglomeration apparatus at 1120 to produce small seed granules. In some embodiments, the seed granules have a size in the range of about 1 mm to about 2 mm in diameter, including any value or subrange therebetween, e.g. about 1.1, 1.2, 1.3, 1.4, 1.5, 1.6, 1.7, 1.8 or 1.9 mm in diameter. The person skilled in the art can control the amount of water added at 1120, the viscosity of the aqueous solution added at 1120, and/or the speed or other parameters at which the agglomeration apparatus, e.g. pin mixer, is operated in order to regulate the size of the seed granules produced by the agglomeration apparatus at 1118. In some embodiments, after passing through the agglomeration apparatus, the absorbent core has a moisture content by weight in the range of about 20% to about 50%, including any value or subrange therebetween, e.g. about 21, 22, 23, 24, 25, 26, 27, 28, 29, 30, 31, 32, 33, 34, 35, 36, 37, 38, 39, 40, 41, 42, 43, 44, 45, 46, 47, 48 or 49% moisture content by weight.

At 1122, the seed granules produced by the agglomeration apparatus at 1118 are discharged, for example into the coating apparatus, for example a pan granulator, to be coated with outer clumping coating 1014.

In one specific example embodiment, to prepare the absorbent core 1012, approximately 5900 kg of diatomaceous earth are combined with approximately 400 kg of corn starch and 250 kg of powdered corn syrup in a rotary batch mixer (for example a Rollo-Mixer™). Separately, 143.4 g of citric acid and 5 g of pre-gelatinized corn starch are added to each L of water to yield a citric acid solution. 4000 kg of the citric acid solution is added to the dry ingredients in the rotary batch mixer and combined to yield a slightly moist, non-dusty powder mix.

The moist powder ingredients are then transferred to the feed system for supply to an agglomeration apparatus such as a pin mixer, where another 1600 kg of tap water are added to the 10550 kg mixture (or approximately 151.6 kg of water per tonne of processed moist powder). This results in the production of small seed granules as the material passes through the agglomeration apparatus that applies mechanical energy to the mixture that agglomerates the material. The seed granules are ideally in the size range of about 1 mm to about 2 mm in diameter in some embodiments. The amount of water addition, the viscosity of the solution created by combining the water, citric acid and pre-gelatinized corn starch, and the pin mixer speed can be used by the person skilled in the art to control the final size of the absorbent core. In one example embodiment, the absorbent core has approximately 28% moisture content by weight after passing through the agglomeration apparatus.

In another specific example embodiment, to prepare the absorbent core 1012, approximately 5900 kg of diatomaceous earth are combined with approximately 100 kg of corn starch as the dry cohesive binder and 700 kg of carboxymethyl cellulose as the core hardening binder. Separately, an aqueous solution is prepared by adding 143.4 g of citric acid and 5 g of pre-gelatinized corn starch as a cohesive binder to each L of water to yield a citric acid solution. 4000 kg of the citric acid solution is combined with the dry ingredients in an appropriate mixing system, e.g. a Rollo-Mixer™.

The moist powder ingredients are transferred to the feed system for supply to an agglomeration apparatus such as a pin mixer, planetary mixer or the like that applies mechanical energy to the mixture that agglomerates the material. Another 3260 kg of tap water are added to the 10700 kg mixture, or 304.6 kg of water per tonne of processed moist powder, to facilitate the production of small seed granules. The seed granules are ideally in the size range of about 1 mm to about 2 mm in diameter in some embodiments. The amount of water addition, the viscosity of the solution created by combining the water, citric acid and pre-gelatinized corn starch, and the pin mixer speed can be used by the person skilled in the art to control the final size of the absorbent core. In this example embodiment, the absorbent core has approximately 42% by weight moisture content after passing through the agglomeration apparatus.

### Outer Clumping Coating—Second Embodiment

The coating powder for preparing outer clumping coating 1014 is prepared from a material that will cause the composite particles to clump together when exposed to moisture. In some embodiments, the coating powder contains fine bentonite powder that in combination with a clumping binder acts as a clumping agent. In some embodiments, the coating powder contains an absorbent coating material and a clumping binder that acts as a clumping agent. In some embodiments, the outer clumping coating 1014 contains a hardening binder.

In some embodiments, the coating material is aluminosilicates or hydrous aluminum silicates, phyllosilicates, tectosilicates, nesosilicates/orthosilicates, or siliceous rocks, including for example clay, volcanic clays, zeolites, bentonite, diatomaceous earth, montmorillonite, Fuller's earth, silicates, attapulgite, smectites, kaolinite, hormites, sepiolite, halloysite, metakaolin, hectorite, vermiculite, fly ash, muscovite, biotite, chlorite, hallyosite, illite, quartz, feldspar, micas, andalusite, kyanite, sillimanite, leucite, faujasite, analcime, nepheline, prehnite, pumice, gypsum, alumina, perlite, calcite, dolomite, or the like In some embodiments, the coating material is a mixture of diatomaceous earth and bentonite. In some embodiments, the coating material is bentonite. In some embodiments, the coating material is bentonite fines.

In some embodiments, the coating material is provided as a fine powder. In some embodiments, the coating material is a fine powder that has a diameter of less than about 850 microns, including less than 800, 750, 700, 650, 600, 550, 500, 450, 400, 350, 300, 250, 200, 150 or 100 microns. In some embodiments, the coating material is a fine powder that has a diameter of between about 100 and about 850 microns, including any value or subrange therebetween.

In some embodiments, the coating material is present in an amount of between about 30% and about 45% by weight of the dry matter of composite particle 1010, including any value or subrange therebetween, e.g. about 31, 32, 33, 34, 35, 36, 37, 38, 39, 40, 41, 42, 43 or 44% by weight on a dry matter basis of the weight of composite particle 1010.

In some embodiments, the clumping binder is a gum such as gellan gum, xanthan gum, guar gum, carob bean gum, Arabic gum, cellulose gum, carrageenan, tara gum, konjac gum, or the like. In some embodiments, the clumping binder is a natural gum. In some embodiments, the clumping binder is a high temperature resistant gum. In some embodiments, the clumping binder is gellan gum. In some embodiments, the clumping binder is a binder that retains and exhibits adhesive qualities after formulation in order to facilitate clumping of composite particles 1010 upon their exposure to moisture. In some embodiments, the clumping binder is cornstarch.

In some embodiments, the clumping binder is present in an amount of between about 1% and about 10% by weight on a dry matter basis of the weight of composite particle 1010, including any amount therebetween, e.g. about 1.5, 2.0, 2.5, 3.0, 3.5, 4.0, 4.5, 5.0, 5.5, 6.0, 6.5, 7.0, 7.5, 8.0, 8.5, 9.0, or 9.5% by weight on a dry matter basis of the weight of composite particle 1010.

In some embodiments, the coating hardening binder is a hardening agent such as corn syrup (including powdered corn syrup), copovidone, carboxymethylcellolse (CMC), or the like.

In some embodiments, the coating hardening binder is present in an amount of between about 2% and about 20% by weight on a dry matter basis of the weight of composite particle 1010, including any amount therebetween, e.g. about 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0 or 19.5% by weight on a dry matter basis of the weight of composite particle 1010.

In one specific example embodiment, the coating material is a powder that is made from fine bentonite powder and two different binders, a high temperature resistant gum (for example, gellan gum) as a clumping binder and a coating hardening binder (for example, powdered corn syrup). The relative proportions used are, by dry weight relative to the total weight of the outer clumping coating 1014, 71.4% fine bentonite powder, 9.5% gellan gum and 19% powdered corn syrup. These dry ingredients are combined in a suitable mixing apparatus such as a rotary batch mixer such as a Rollo-Mixer™.

In another specific example embodiment, the coating material is a powder made from fine bentonite powder and two different binders, a high temperature hardening binder such as carboxymethyl cellulose (CMC), which can optionally be partially mixed with cornstarch as a clumping binder. In this example embodiment, the coating material is approximately 80% bentonite, about 15% to about 20% CMC and about 0 to 5% cornstarch by mass, taken as the percentage dry weight of the outer clumping coating 1014.

In still a further example embodiment, the coating material used to make clumping coating 1014 can be any of the coating materials described previously with reference to clumping coating 14 as used in the manufacture of composite particle 10, for example, a combination of a coating material such as bentonite and a binder such as a polysaccharide binder such as carboxymethyl cellulose (CMC), a starch, a modified starch, a dextrin, a modified dextrin, or the like, which has been subjected to a heat treatment step to dry the material at a temperature of between about 90° C. and 115° C. as described above with reference to the production of clumping coating 14.

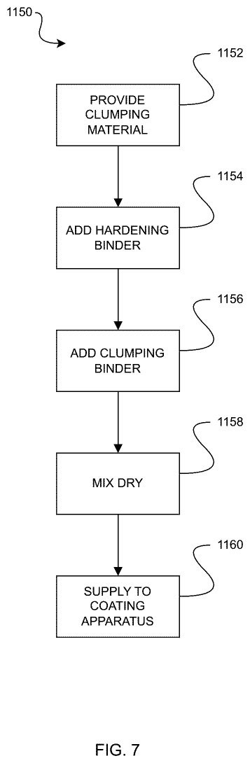

With reference to FIG. 7 which illustrates a method 1150 of preparing a clumping coating according to one example embodiment, the coating material, for example finely powdered bentonite, is supplied at 1152 and is combined with one or more binders, for example a clumping binder such as a high temperature gum such as gellan gum at 1156 and a coating hardening binder such as powdered corn syrup or carboxymethylcellulose (CMC) at 1154. At 1158, the coating material and the one or more binders are combined together in any suitable mixing apparatus for combining dry ingredients, such as a rotary batch mixer such as a Rollo-Mixer™. At 1160, the coating material is supplied to the coating apparatus to coat the absorbent core to form the desired composite particle.

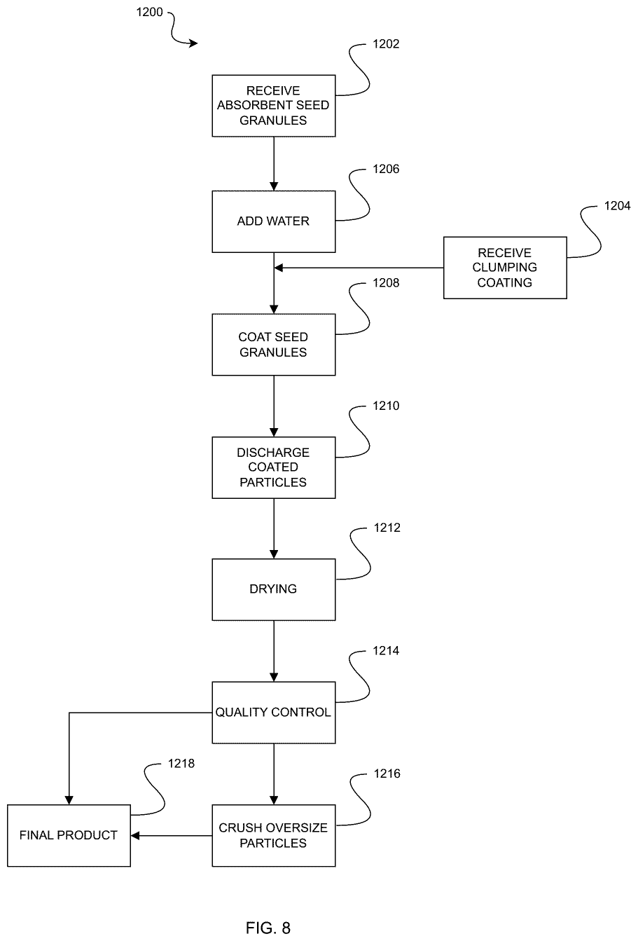

To apply the outer clumping coating to the absorbent core, as illustrated in FIG. 8 which shows an example embodiment of a method 1200 for applying the clumping coating to the absorbent core to form a composite particle according to one example embodiment, at 1202 the seed granules of the absorbent core discharged at 1122 are received in a suitable apparatus for applying the clumping coating, for example a pan granulator, a disc pelletizer, a drum coater, or the like. At 1204, the clumping coating discharged at 1160 is also received by the apparatus for applying the clumping coating.

In one example embodiment, a pan granulator is used in method 1200 to coat the absorbent core with the clumping coating. In some embodiments, the pan granulator is set up with a secondary powder feed for applying the clumping coating at 1204, and a water spray system to add water at 1206, to increase the moisture content and adhesion and cause agglomeration of the dry clumping coating onto the seed granules of the absorbent core as the dry clumping coating is applied. In one particular example embodiment, the water spray system is set up to spray granules in the upper front quadrant of the pan granulator, and the addition of the clumping coating is carried out only in the lower back quadrant of the pan granulator, so that the clumping coating powder itself does not agglomerate but rather coats the existing seed granules of the absorbent core at 1208. In some embodiments, the water spray at 1206 is applied at or near the top of the path of travel of the seed granules, and the clumping coating powder at 1204 is added at or near the bottom of the path of travel of the seed granules.

In other words, the process conducted in method 1200 is a coating process and does not result in the formation of any significant number of new granules formed of just the clumping coating. The operation of a pan granulator to coat existing seed particles would be known to one skilled in the art, as for example described in A. A. Lipin and A. G. Lipin, “Particle coating with composite shell in a pan granulator”, Particulate Science and Technology, 40(1): pp. 123-130, published online: 24 May 2021, doi.org/10.1080/02726351.2021.1927272.

In one example embodiment, the coating process conducted in method 1200 utilizes a powder addition at a mass rate at 1202 of approximately 80% dry coating powder mass to the mass rate of wet core seed granules being supplied at 1204. At 1206, a spray of water at a mass rate of approximately 35% of the coating powder mass addition is continuously sprayed on the formed granules during the coating process. As a specific example, if 100 kg per hour of wet seed granules (i.e. absorbent core 1012) are passing through the pan granulator, 80 kg of coating powder per hour should be applied for coating along with a water spray of 28 kg per hour to facilitate the powder adhesion and the coating process.

In some embodiments, the pan granulator is set up so that coated composite particles having a diameter of between about 2.0 and about 2.5 mm, including any value therebetween, e.g. 2.1, 2.2, 2.3 or 2.4 mm, exit the process at 1210 and are conveyed to a drying apparatus for drying at 1212. In one specific embodiment, the pan granulator is set up so that coated composite particles having a diameter in the range of about 2.3 mm exit the process at 1210.

In some embodiments, any suitable drying apparatus can be used at step 1212, for example a drum dryer, belt dryer, fluidized bed dryer, or the like. In some embodiments, a maximum temperature at which the produced composite particles are dried is less than about 105° C. In some embodiments, the composite particles are dried to a moisture content of about 7% water by weight or lower, e.g. about 6.5%, 6% or 5.5% moisture content. Other drying temperatures and final moisture contents could be used if desired, balancing considerations such as the maximum temperature to which any of the components of the composite particles, particularly the clumping binder, can be exposed, and the increased energy that may be required to reach lower moisture contents.

In some embodiments, a quality control step 1214 is applied after drying step 1212. For example, in some embodiments, the composite particles are screened after drying to ensure that composite particles having larger than a predetermined size is not present in the final product. For example, in some embodiments, after screening, any particles having larger than the desired predetermined size are transferred to a roller crusher system at 1216 and fractured, so that the fractured granules can be added to the final product at 1218. In some embodiments, an ideal size range for the final product is between about 1.4 mm to about 2.3 mm in diameter, including any size or subrange therebetween, e.g. about 1.5, 1.6, 1.7, 1.8, 1.9, 2.0, 2.1 or 2.2 mm in diameter.

### EXAMPLES

Further exemplary embodiments are illustrated with reference to the following examples, which are intended to be illustrative and not limiting in nature.

### Example 1.0—Clumping Test Protocol

Generally speaking, depending on amounts of material available, ˜30 or ˜45 grams of composite particles were deposited in small (4 inch) tinfoil pans and 10 ml of warm water was added in one spot to each. A piece of wax paper was placed in the bottom of the foil pans for this test to aid in removing the clumps without disturbing them since sticking to the foil was observed in the previous tests. Depending on the test conducted, after a time period of 5 minutes or 20 hours the clumps were isolated and removed from the pan and weighed, the clumps were then dropped from 12 inches onto a 6.8 mm screen and the largest remaining clump was weighed. The clump strength is the fraction in percentage of the largest clump mass divided by the original clump mass.

For expediency, in the following examples the “as is” powders were treated as dry (little or no moisture content). However, those skilled in the art can make adjustments to the formulation based on a true dry matter formulation.

### Example 2.0—Materials Used in Testing of Various Exemplary Particles

Materials used in these examples had the following properties:
DE Fines with a density of 402 kg/m³ or 25.1 lbs/ft³ where specifically noted, or otherwise having a density of 494 kg/m³ or 30.8 lbs/ft³
Bentonite Fines with a density of 1132 kg/m³ or 70.7 lbs/ft³
Carboxymethyl Cellulose (CMC), high viscosity CMC 2500 with a density of 722 kg/m³ or 45.1 lbs/ft³.
Carboxymethyl Cellulose (CMC), low viscosity Tylose® having a viscosity of approximately 300 cP with a density of ˜722 kg/m³ or 45.1 lbs/ft³
Rice granules from 1-1.4 mm and 1.4 to 2 mm in diameter with a density of 910 kg/m³ or 56.8 lbs/ft³.
Sodium polyacrylate with a density of 735 kg/m³ or 45.8 lbs/ft³.
Tap water.

### Example 3.0—Utility of Carboxymethylcellulose (CMC) as a Binder for Bentonite Coating

Early trials using a diatomaceous earth (DE) absorbent core seed particle coated with bentonite showed promise, but the clumping properties of such composite particles were less than desired. CMC was investigated as a possible binder to assist in enhancing the clumping properties of the bentonite coating.

The absorbent core is described in this Example as Part A and the clumping coating is described in this Example as Part B. To make Part A, generally unless otherwise noted a pin mixer action was simulated by using a small hand whisk in a stainless steel bowl. Water and citric acid were combined and then added to the mixed dry ingredients by misting on intermittently until a tacky (but not sticky) material with a consistency similar to brown sugar formed and began to granulate. Once the right consistency was reached, the material was sieved into fractions between 1 mm and 2 mm and larger than 2 mm. To make Part B, the granules produced in Part A that were added to a drum turning at 51 RPM with a partially closed face and gradually sprinkled with the pre-mixed Part B powder and intermittently misted with tap water such the Part B predominately coated the existing granules and did not permit agglomeration of Part A seed granules themselves or the Part B coating alone.

### Example 3.1—CMC as a Core and Shell Binder with Citric Acid Core

This example was conducted to evaluate the efficacy of CMC (Tylose®) as a binder in both the core and coating of the composite particle. Recipe for Part A:
The water citric acid mixture consisted of 38 grams of citric acid in 225.6 grams of water and to this mixture 1.2 grams of pre-gelatinized corn starch was added to increase the viscosity. This mixture represented a pre-gelatinized starch addition rate of 4.5 grams/Litre of final acid water. Only a portion of this liquid was used to form the core granules.
29.5 grams of a first source of DE having a density of 402 kg/m³ and 29.5 grams of a second source of DE having a density of 494 kg/m³, 8 grams of CMC and 41 grams of the viscous acid water were mixed together to form a dust free damp powder. Once homogenous, 31.4 grams of tap water was added to bring the mixture to the right consistency for granule formation.

### Recipe for Part B:

Bentonite mixed with binder to coat the exterior of the produced smaller granules. The amount of shell material supplied was ˜80% of the wet mass of the core material. The shell material was 80% bentonite, 20% CMC by mass for one sample, and for the second sample diatomaceous earth was used with bentonite for a 36% bentonite, 28% DE and 36% CMC by mass. Final mixes were:
   For sample A, 50 grams of core granules were formed and 32 g of bentonite plus 8 grams of CMC mixed with 11.8 grams of tap water were added as the coating.
   For sample B, 50 grams of core granules were formed and 6 g of DE and 8 g of bentonite with 8 grams of CMC along with 15.4 grams of tap water were coated on the exterior of the shell.

Results. Part A. The core granules generated and formed in the mixing bowl and on the 1.4 mm and 2.36 mm shaken screen when the moisture threshold was reached appeared reasonable. The granules generated appeared to be of reasonable size although some oversize was produced but it mostly brushed through the 2.36 mm sieve. A total of 72.4 g of water was added to place the mixture in a granulating state. Part B. The core granules coated adequately although it appeared the granules were somewhat undersize of the target size. During drying the granules had a tendency to stick together and need agitation to separate them at the early stages of drying. Table 1 shows the results for the density, hardness and clumping strength. Both samples had good granule strength with about half being considered very hard and much of the rest medium hardness. The bulk density of the samples were extremely low, and as was seen with MCC appears to correlate with water uptake (more water uptake, lower density after drying), implying the water evaporates leaving a porous structure intact. Interestingly, the bentonite based shell had excellent clumping results while the DE mixed sample had very poor clumping results, implying without being bound by theory that the bentonite plays a role with the binder in the clumping mechanism.

TABLE 1
Density, hardness and clumping test results.

| Material/ | | Hardness | | | Clumping |
|---|---|---|---|---|---|
| Parameter | Density | # Soft | # Med | # Very Hard | Strength |
| Sample A | 379.1 kg/m³ | 0 | 4 | 6 | 18.10 g clump |
| (CMO) | 26.3 lbs/ft³ | | | | 97.5% |
| Sample 8 | 406.4 kg/m³ | 2 | 4 | 4 | 16.81 g clump |
| (CMC | 28.2 lbs/ft³ | | | | 23.8% |
| with DE) | | | | | |

Without being bound by theory, it is believed that the low density of the final material produced in this Trial coincides with the high water uptake during granulation.

### Example 3.2—CMC as the Primary Core and Shell Binder

Based on the success observed with lightweight aggregate development and Example 3.1, further work was done using CMC as the primary binder for the core and shell. A slight addition of corn starch to the core was used to see if better granule size could be obtained and in the shell additional cornstarch was used in conjunction with the CMC binder.

### Recipe for Part A:

The water citric acid mixture contained 38 grams of citric acid in 225.6 grams of water and to this mixture 1.2 grams of pre-gelatinized corn starch was added to increase the viscosity. This mixture represented a pre-gelatinized starch addition rate of 4.5 grams/Litre of final acid water. Only a portion of this liquid was used to form the core granules.
29.5 grams of the first source of DE, 29.5 grams of the second source of DE, 7 grams of CMC, 1 gram of corn starch and 40 grams of the viscous acid water were mixed together to form a dust free damp powder. Once homogenous 32.6 grams of tap water was added to bring the mixture to the right consistency for granule formation.

### Recipe for Part B:

Bentonite mixed with binder to coat the exterior of the produced smaller granules. The amount of shell material supplied was ˜80% of the wet mass of the core material. The shell material was 80% bentonite, 20% CMC by mass for the first sample, and for the second sample the mixture was 80% bentonite, 5% corn starch and 15% CMC by mass. Final mixes were:
   For sample A, 50 grams of core granules were formed and 32 g of bentonite plus 8 grams of CMC mixed with 12.8 grams of tap water were added as the coating.
   For sample B, 50 grams of core granules were formed and 32 g of bentonite with 2 grams of corn starch and 6 grams of CMC along with 15.87 grams of tap water were coated on the exterior of the shell.

Results. Part A. The core granules generated and formed in the mixing bowl and on the 1.4 mm, 2.0 mm and 2.8 mm shaken screens when the moisture threshold was reached appeared reasonable. Moisture control alone did seem to produce target size core granules. Once the mixture became too wet the process still had a considerable amount of fine material but also began to generate oversized material. However, the oversize material did readily brush through the larger sieve yielding more ideal size core granules. Material that was retained by the 2 mm sieve was used for sample A and small granules that were retained by 1.4 mm sieve were used for sample B. As before, the CMC appears to hold a considerable amount of water since after the 40 grams of acidic water was added the material still appeared dry. Additionally, the mixture required another 32.6 g of water to be in a granulating state. It seems the corn starch did help create cores that were slightly less “puffy” than CMC alone. Part B. The core granules coated very well in this case with normal water requirements. It was observed on the smaller granules that if the material was moistened too much it became sticky in the coating drum. Ultimately it appeared the sample A granules were very near the target size, while sample B granules were undersize. During drying the granules tended to stick together and need agitation to separate them at the early stages of drying (more-so for sample B than A). Table 2 shows the results for the density, hardness and clumping strength. The larger granules had excellent hardness and surprisingly again the small granules still had reasonable strength with 40% very hard. The bulk density of both samples was in a very desirable target range around 30 pounds per ft³. Both samples had excellent clumping results and no pooling of the liquid on the surface was observed during the water application part of the clump test, although there was moisture in the bottom of the foil suggesting that some of the water may have passed directly through the litter.

TABLE 2
Density, hardness and clumping test results.

| Material/ | | Hardness | | | Clumping |
|---|---|---|---|---|---|
| Parameter | Density | # Soft | # Med | # Very Hard | Strength |
| Sample A | 428.6 kg/m³ | 1 | 1 | 8 | 18.74 g clump |
| (CMC with | 29.7 lbs/ft³ | | | | 96.5% |
| larger cores) | | | | | |
| Sample B | 434.2 kg/m³ | 2 | 4 | 4 | 18.27 g clump |
| (CMC with | 30.1 lbs/ft³ | | | | 97.0% |
| Corn Starch) | | | | | |

Once again, the CMC binder in combination with the bentonite yielded very good clumping results and the partial corn starch substitution for CMC in Sample B showed equal clumping performance, although the particle size was smaller which has been demonstrated to have clumping advantages. This formulation also has no observable surface pooling, although moisture was observed at the bottom of the foil tray.

### Example 4.0—Screening of Different Binders in Loose Powder Mixtures

The inventors observed that loose material containing a blend of bentonite and carboxymethyl cellulose (CMC) exhibited undesirable pooling of water on the surface of the litter. The addition of CMC to the bentonite was found to produce a more robust clump (i.e. provides higher clump strength), but was also found to contribute a sealing or repellent effect that precludes the effective penetration of water into the bentonite powder. Such repellency is undesirable for an animal litter product, as this may lead to liquid penetrating too deeply into the litter, potentially even resulting in pooling of liquid at the bottom of the litter pan or sticking of material to the bottom of the litter pan.

The inventors anticipated that the poor water penetration observed with CMC combined with bentonite as a loose powder would also be observed in granules containing such material. Further testing with sample two-part particles with a core formed of rice (for expediency and consistency in testing purposes) confirmed this to be the case, and two-part granules coated with a mixture of bentonite and CMC as a clumping binder exhibited poor water penetration, although desirable properties in terms of generating clumps that have a high strength quickly upon exposure to water. Without being bound, it is believed that the CMC may form a hydrogel on the surface of the particles and that this hydrogel enhances the clumping properties and clumping strength of the bentonite-coated particles but also prevents effective water penetration through the surface, causing applied liquid to travel deep into the litter which is anticipated to be likely to cause undesirable tall cylindrical clumps rather than the more traditional puck-shaped clumps observed in typical animal litters.

### Example 5.0—Heat Treatment of CMC with Bentonite

This example attempted to combine the CMC (Tylose®) with bentonite in a synergistic manner so that the binding nature of the CMC and the absorptive properties of the bentonite worked together. This example involved generating an intermediate CMC-bentonite clay which was dried at elevated temperature and ground to form a powder, and then applying it to core granules.

Part 1. 300 ml of tap water was heated by microwave to 60° plus, and a high shear mixer was used to create a vortex as 6 grams of CMC was added to the water. This yielded a homogenous thin syrup like liquid that was very manageable. 250 ml of this syrup was then transferred to a mixing container and a high shear mixer was used to blend in 100 grams of bentonite powder. This yielded a homogenous thick mud with pudding like consistency. The bentonite CMC mud was then transferred to a silicon baking dish and the material was oven dried at 102° C. for approximately 10 hours. The resulting dried cake was then size reduced with a mortar and pestle until it could pass a 710 micron screen.

Part 2. The resulting powder from part 1 was tested alone as a powder and was applied to cores made from rice for expediency. For the powder test 15 grams of the formulated powder was dosed with 5 ml of water as was pure a bentonite sample for comparison. After observing a clear improvement in water absorbency, granules were formed by coating 50 grams of the large cores with 34 grams of the baked/formulated CMC-bentonite powder and 21.94 grams of water. The particles were dried at 102° C. for about 3 hours before further use in a clump test. With this formulation the 50 grams of core would be coated with only 1.7 grams of CMC, which is significantly less than the 8 grams commonly used in earlier testing without heat treatment. Without being bound by theory, it is believed that the addition of more water and/or the addition of a further binder to the coating material and/or to the water being sprayed on the seed granules during the coating process could enhance the amount of clumping coating applied to the absorbent core.

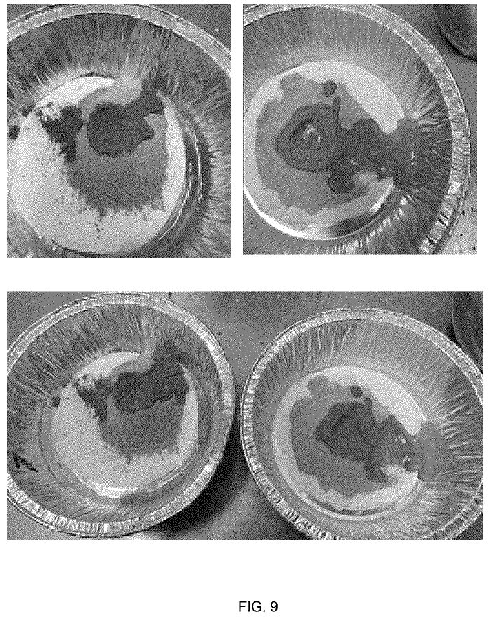

Results. FIG. 9 shows how the dried (baked) CMC-bentonite mixture as a powder absorbs water much more readily than pure bentonite. The images are immediately after water application (upper images) and at 5 minutes after water application (lower images); the heat-treated CMC bentonite powder is shown in the images on the left and raw bentonite is shown in the images on the right. This is in contrast to previous trials where simply mixed CMC-bentonite mixtures had severe surface water puddling on the surface. Upon clump testing, it was observed that the clump was somewhat weak and broke apart, but the water did not seem to deeply penetrate and pass through the granules and the overall clump seemed to have swollen more than normal. Residual fines were observable after the coated cores were dried, which implies that coating adhesion could be improved.

### Example 6.0—Increased CMC Concentration

This example focused on producing a dried/baked CMC-bentonite mixture with a higher yet CMC concentration and ascertaining if the increased CMC concentration further improved water absorbency and clumping of coated granules. The CMC (Tylose®) addition to water during this trial matched the recommended solubility limit of 50 gram/L.

Part 1. 300 ml of tap water was heated by microwave to 60° plus, and a high shear mixer was used to create a vortex as 15 grams of CMC was added to the water. This yielded a homogenous noticeably viscous syrup like liquid that was still manageable. 300 ml of this viscous liquid was then transferred to a mixing container and a high shear mixer was used to blend in 80 grams of bentonite powder (an approximately 1:5 ratio by weight of CMC:bentonite). This yielded a homogenous thick mud with drywall mud like consistency. Mixing this mud was not particularly conducive to small propeller high shear mixing and slow moving, large aggressive mixing blades would potentially be more suitable. The bentonite CMC mud was then transferred to a silicon baking dish and the material was oven dried at 102° C. for approximately 10 hours. The resulting dried cake was then size reduced with a mortar and pestle and then a coffee grinder until it could pass a 710 micron screen.

Part 2. The resulting powder from part 1 was applied to cores made from rice as done previously. In this coating process two samples were produced. First, 50 grams of rice granules (½ large and ½ small) were coated with 40 grams of the CMC-bentonite powder using 21.3 g of water to aid in the binding. With this formulation the 50 grams of core would be coated with ˜7.5 grams of CMC, which is very similar to the 8 grams used in previous experiments using simply mixed (i.e. not heat-treated) CMC-bentonite trials that generated strong clumps.

Results. The clump developed a crack during the clump strength drop test, but remained intact such that the 27.04 gram core scored 97.15% recovery in the test. However, further manipulation of the clump after a few hours drying revealed that this clump did not develop into a hardened secure clump that is normally the case with CMC treated materials, but remained or became even more friable and somewhat delicate. The remaining granules after the clump was recovered had no notable moisture invasion through the clumped granules into the residual granules, indicating the dehydrated CMC-bentonite mixture very readily absorbed the water dose and did not let is pass through.

The work conducted during this example confirmed again that with increasing dehydration embedment of the CMC into bentonite, the clumping and water holding capabilities of the CMC-bentonite mixture continued to improve. However, at the concentration prepared for this trial, it was surprising that the clump did not exhibit stronger properties. Although the clump did pass the drop test the clump nature was not as long-lasting as is desired.

### Example 7.0—Heat-Treated CMC Bentonite Applied to DE Seed Granules

This example focused on producing a dehydrated CMC-bentonite mixture with CMC (of two types) and applying it to DE seeds created by roller compaction. The DE seeds were created by mixing DE powder with water and subjecting this powder to a roller compactor and screening to produce a desirable size of 1 mm to 1.8 mm granule that was coated with the dehydrated CMC-Bentonite powder. In this trial the DE granules were further screened to make 1 mm to 1.4 mm and 1.4 mm to 1.8 mm seed materials having a density of 821.6 kg/m³ or 51.2 lbs/ft³ before drying. This material was coated with a high viscosity CMC bentonite mix (CMC-2500) and a low viscosity CMC-bentonite mixture (Tylose®). For the low viscosity mixture, a dilute aqueous CMC mixture (0.5% by weight) was prepared and sprayed on the granules instead of a plain water spray to improve the adhesion of the powder to the core granules.

Part 1. DE fines and water were mixed to achieve ˜a 10% moisture powder that was utilized directly in the roller compactor. The produced hard granules were screened to deliver a 1 mm to 1.8 mm fraction of mixed granules for coating. A sample of these mixed granules was further hand sieved to create a particle fraction of 1-1.4 mm and 1.4 to 1.8 mm.

Part 2. 600 ml of tap water was heated by microwave to 70° plus, and a high shear mixer was used to create a vortex as 20.7 grams of CMC-2500 was added to the water. This yielded a homogenous thick paste that was at the limits of remaining manageable. 150 grams of bentonite was then added to the CMC paste and blended in with a hand blender (an approximately 1:7 parts by weight ratio of CMC:bentonite). Additionally, a low viscosity CMC mixture was also prepared using 300 ml of water, 15 grams of CMC (Tylose® having a stated viscosity of approximately 300 cP) and 75 grams of bentonite as before (an approximately 1:5 parts by weight ratio of CMC:bentonite). This yielded a much less viscous flowable paste. The bentonite CMC muds were then transferred to a silicon baking dish and a tin foil dish and oven dried at 102° C. for approximately 21 hours. The resulting dried cake was then size reduced with a mortar and pestle and then a coffee grinder until it could pass a 710 micron screen.

Part 3. A first test sample was created when the resulting dehydrated CMC-2500 powder from Part 2 was applied to cores made from DE from Part 1. In this coating process 50 grams of the DE granules with 80% larger than 1.4 mm and 20% in the 1-1.4 mm range were coated with 40 grams of the dehydrated CMC 2500-bentonite powder using 35 g of water to aid in the binding. With this formulation the 50 grams of core would be coated with ˜4.9 grams of CMC.

In the second sample, the low viscosity dehydrated CMC-bentonite powder was also applied to the mixed DE granules with 80% larger than 1.4 mm and 20% between 1-1.4 mm. In this scenario 50 grams of DE granules were coated with 40 grams of dehydrated CMC-bentonite powder. This was adhered to the granules with 44.44 grams of 0.5% by weight CMC aqueous solution that was tested as an adhesion agent. This yielded coated granules with ˜6.7 grams of CMC.

Results. The density of the high viscosity CMC-bentonite coated DE granules was measured to be 646.1 kg/m³ or 40.3 lbs/ft³ after drying and the low viscosity CMC-bentonite coated DE granules had a density of 619.7 kg/m³ or 38.7 lbs/ft³, both of which are quite suitable for a lightweight litter.

Reasonable clumps were formed that survived the drop test with ease. During the clump test 23.03 gram and 24.24 gram clumps were recovered from the high viscosity and low viscosity coated samples respectively and the drop test yield clump strengths of 92.4% and 90.6% respectively. Although this is technically considered a fail for the drop test, it was considered to be a significant improvement over the results of other trials where clumps completely fell apart. It should also be noted that the formed clumps were isolated cakes on the surface on the surface and deep water penetration was not an issue. After some handling of the clumps post drop test cracks were forming and it was clear these clumps would eventually fail with rough handling unlike some litters that form rather indestructible clumps. The coating on this trial appeared somewhat better and more uniform color was observed but the coating nature could still potentially be improved.

### Example 8.0—Lower Density DE Seed Granules with Heat-Treated CMC Bentonite Coating

This example focused on using a dehydrated low viscosity CMC-bentonite mixture and applying it to DE seeds created by roller compaction and were produced with more gap on the roller compactor to reduce density. The DE seeds were created by mixing DE powder with water and subjecting this powder to a roller compactor and screening to produce a desirable size of 1.2 mm to 1.7 mm granule that was coated with the dehydrated CMC-Bentonite powder.

Part 1. DE fines and water were mixed to achieve ˜a 10% moisture powder that was utilized directly in the roller compactor DE powder. The produced hard granules were screened to deliver a 1.2 mm to 1.7 mm fraction of mixed granules for coating.

Part 2. 300 ml of tap water was heated by microwave to 70° plus, and a high shear mixer was used to create a vortex as 15 grams of low viscosity CMC (Tylose®) was added to the water. This yielded a homogenous flowable syrup like mixture to which 75 grams of bentonite was added and blended in with a hand blender (a 1:5 by weight ratio of CMC:bentonite). The bentonite CMC mud was then transferred to a silicon baking dish and oven dried at 102° C. for approximately 21 hours. The resulting dried cake was then size reduced with a mortar and pestle and then a coffee grinder until it could pass a 710 micron screen.

Part 3. The low viscosity dehydrated CMC-bentonite powder was applied to the DE granules, with 50 grams of DE granules coated with 40 grams of dehydrated CMC-bentonite powder. This was adhered to the granules with 30.5 grams of tap water by misting the DE during drum coating while the bentonite was sprinkled onto the tumbling granules.

Results. The density of the low viscosity CMC-bentonite coated DE granules was measured to be 641.4 kg/m³ or 40 lbs/ft³ after drying. Reasonable clumps were formed that survived the drop test. It was also observed in this trial that the coated granules had a nice size distribution.

During the clump test a 22.1 gram clump was recovered and the drop test yielded clump strengths of 96%. It was observed that some moisture penetrated to the bottom of the granules, so a penetration test was performed on the residual granules in a 50 mL vial. In this penetration test 10 mL of water applied to the surface granules and after 5 minutes the loose granules were removed to determine how deep the water penetrated and coagulated granules. The penetration was an acceptable 1.5 inches considering the narrow water placement zone in this small vial.

The good clumping performance of this trial confirmed that the 15 g of CMC in 75 g of bentonite or a 1:5 ratio is a good starting point for a range to provide good clumping efficacy, and it can be achieved with low viscosity CMC. The penetration test shows the dehydrated CMC-bentonite can absorb the moisture effectively.

### Example 9.0—Ammonia Testing Protocol

A primary cause of odour emission from cat litter boxes is the volatilization of ammonia from the urine. Cat urine contains a minor amount of ammonia (˜1.4 mg/L) and approximately 53.5 g/L of urea, which in the presence of urease rather rapidly and significantly converts to ammonia (Hannah Ray, Daniella Saetta and Treavor H. Boyer, Characterization of urea hydrolysis in fresh human urine and inhibition by chemical addition, Environ. Sci.: Water Res. Technol., 2018, 4, 87). Ultimately the urea hydrolysis process converts at least 43% of the urea to ammonia (David E. Kissel, Management of Urea Fertilizers, Kansa State University, 1998), so it is reasonable to assume cat urine can yield ˜14.5 g/L of ammonia.

A simple ammonia dosing test was used to examine various cat litters including some prototype litter samples produced (Table A1). Briefly, a Drager Xam-5000 ammonia detector was used to detect ammonia. 200 mL of a representative litter sample was placed into a 500 mL beaker. 2 mL of household ammonia was added to each test beaker, and the beaker was covered with parafilm. Samples were permitted to stand, and readings were taken at 1, 4, 8 and 24 hours using the ammonia detector. The maximum level of ammonia detectable by the sensor is 300 ppm.

The results shown in Table A1 indicate that the citric acid in the absorbent core has a strong impact on the removal at the beginning of the tests and an even stronger effect is observed if the test is repeated. The results confirm the effectiveness of the citric core, although with the tested 7% citric acid by dry matter content, these samples may have contained more citric acid than is necessary for effective odour removal. A target of ˜3.8% pure citric acid (assuming the raw citric acid product is 35% moisture) is being targeted in current testing.

The ammonia testing method below uses household ammonia solution to generate the ammoniacal nitrogen directly. If the 2 ml dosing is with standard 10% ammonia product then a dose of 0.2 grams of NH₃ is being applied to the test media which represents about 40% of what a single urination event would likely produce.

TABLE A1
Ammonia test results from several prototype and commercial litters and base materials.

| | | Early | Early | | | | | | |
|---|---|---|---|---|---|---|---|---|---|
| | | Prototype* | Prototype* | Wunder | Bentonite | | | | |
| | | (citric | (citric | cat | Fines | DE | DE | | Fresh 4 |
| | | acid) | acid) | Clumping | W 123 | Oversized* | Powder* | Tidycats | Life |
| Airborne | | | | | | | | | |
| Ammonia | | | | | | | | | |
| Remaining | | | | | | | | | |
| 1-hour | ppm | 42 | 18 | 70 | 96 | 162 | 133 | 188 | 118 |
| 4-hours | ppm | 17 | 16 | 5 | 16 | 22 | 23 | 36 | 24 |
| 7-hours | ppm | 10 | 9 | 3 | 10 | 12 | 8 | 14 | 12 |
| 24-hours | ppm | 16 | 5 | 0 | 0 | 15 | 4 | 10 | 5 |
| *NH [symbol] | | | | | | | | | |
| reapplied | | | | | | | | | |
| at 24 H | | | | | | | | | |
| 25-hour | ppm | 22 | 21 | 36 | 187 | 166 | 104 | >300 | 135 |
| 28-hours | ppm | 21 | 18 | 15 | 87 | 92 | 64 | 196 | 88 |
| 31-hours | ppm | 18 | 13 | 11 | 41 | 47 | 30 | 52 | 41 |
| 48-hours | ppm | 13 | 4 | 0 | 0 | 0 | 7 | 4 | 0 |

Note:
*samples did not clump. [symbol]
indicates data missing or illegible when filed

A second round of ammonia testing was conducted on later samples with less citric acid in the formulation and other commercial brands for reference (Table A2).

TABLE A2
Second round of Ammonia test results from prototype and commercial litters.

| | | | | | | CMC | | |
|---|---|---|---|---|---|---|---|---|
| Time | | | | | | Polyacrylate | | |
| After | | Special Kitty | Tidy Cat's | [symbol] | [symbol] | [symbol] | [symbol] | [symbol] |
| Dosing | Units | Lightweight | Lightweight | Sample | Sample | DE | Scooping | Traditional |
| [symbol] | | | | | | | | |
| 1-hour | ppm | 171 | ***300 | 39 | 97 | [symbol] | 103 | 70 |
| 4-hours | ppm | 8 | 72 | 10 | 15 | 14 | 17 | 20 |
| 8-hours | ppm | 0 | 0 | 5 | 4 | 8 | 8 | 0 |
| 24-hours | ppm | 0 | 0 | 0 | 0 | 1 | 0 | 0 |
| [symbol] 25-hours | ppm | 123 | 254 | 59 | 81 | 176 | 81 | 65 |
| 28-hours | ppm | 8 | 130 | 21 | 9 | 27 | 17 | 19 |
| 31-hours | ppm | 5 | 82 | 10 | 3 | 13 | 2 | 0 |
| 48-hours | ppm | 0 | 17 | 0 | 0 | 0 | 0 | 0 |

[symbol]

indicates data missing or illegible when filed

### Example 10.0—Testing Various Exemplary Particles With Core Formed by Agglomeration

Materials used in these examples had the following properties:
First Source DE Fines with a density of 402 kg/m³ or 25.1 lbs/ft³
Second Source DE Fines with a density of 494 kg/m³ or 30.8 lbs/ft³
Corn Starch with a density of 624 kg/m³ or 39.0 lbs/ft³
Xanthan Gum with a density of 692 kg/m³ or 43.2 lbs/ft³
Guar Gum with a density of 759 kg/m³ or 47.4 lbs/ft³
Gellan Gum with a density of 740 kg/m³ or 46.2 lbs/ft³
Carboxymethyl Cellulose (CMC) with a density of 722 kg/m³ or 45.1 lbs/ft³
Micro crystalline cellulose (MCC) with a density of 343 kg/m³ or 21.4 lbs/ft³
Lignosulfonate with a density of 679 kg/m³ or 42.4 lbs/ft³
Liquid corn syrup
Powdered corn syrup for a hardening binder with a density of 849 kg/m³ or 53.0 lbs/ft³
Pre-gelatinized corn starch with a density of 582 kg/m³ or 36.4 lbs/ft³
Tap water
Citric acid crystals
Bentonite Fines with a density of 1132 kg/m³ or 70.7 lbs/ft³
   The First Source of DE is a relatively pure source of diatomaceous earth. The Second Source of DE contains some calcium rich bentonite/montmorillonite.

The absorbent core is described in these Examples as Part A and the clumping coating is described in these Examples as Part B. To make Part A, generally unless otherwise noted a pin mixer action was simulated by using a small hand whisk in a stainless steel bowl. Water and citric acid were combined and then added to the mixed dry ingredients by misting on intermittently until a tacky (but not sticky) material with a consistency similar to brown sugar formed and began to granulate. Once the right consistency was reached, the material was sieved into fractions between 1 mm and 2 mm and larger than 2 mm. To make Part B, the granules produced in Part A that were added to a drum turning at 51 RPM with a partially closed face and gradually sprinkled with the pre-mixed Part B powder and intermittently misted with tap water such the Part B predominately coated the existing granules and did not permit agglomeration of Part A seed granules themselves or the Part B coating alone.

Summary of Trials for this Example

| | Absorbent | Cohesive | Core Hardening | Coating | Clumping | Coating Hardening |
|---|---|---|---|---|---|---|
| Trial | Material | Binder | Binder | Material | Binder | Binder |
| 1 | First and | Corn starch | | Bentonite | Xanthan | |
| | Second | | | fines | gum | |
| | Source DE | | | | | |
| 2 | First and | Corn starch | | Bentonite | Xanthan | |
| | Second | | | fines | gum | |
| | Source DE | | | | | |
| 3 | First and | Corn starch | Corn syrup | Bentonite | Corn | Carboxymethylcellulose |
| | Second | | | fines | starch | (CMC) |
| | Source DE | | | | | |
| 4 | First and | Corn starch | Microcrystalline | Bentonite | CMC or | CMC and/or MCC |
| | Second | | cellulose (MCC) | fines | Guar gum | |
| | Source DE | | | | | |
| 5 | First and | Corn starch | MCC | Bentonite | | |
| | Second | and pre- | | fines | | |
| | Source DE | gelatinized | | | | |
| | | corn starch | | | | |
| 6 | First and | Corn starch | MCC | Bentonite | CMC | CMC or MCC |
| | Second | and pre- | | fines | | |
| | Source DE | gelatinized | | | | |
| | | corn starch | | | | |
| 7 | First and | Corn starch | Powdered corn | Bentonite | Gellan | |
| | Second | and pre- | syrup | fines | gum | |
| | Source DE | gelatinized | | | | |
| | | corn starch | | | | |
| 8 | First and | Corn starch | Powdered corn | Bentonite | Gellan | Powdered corn syrup |
| | Second | and pre- | syrup | fines | gum | |
| | Source DE | gelatinized | | | | |
| | | corn starch | | | | |
| 9 | Second | Corn starch | Powdered corn | Bentonite | Gellan | MCC |
| | Source DE | and pre- | syrup | fines | gum | |
| | | gelatinized | | | | |
| | | corn starch | | | | |
| 10 | First and | Corn starch | Powdered corn | Bentonite | Gellan | Powdered corn syrup |
| | Second | and pre- | syrup | fines | gum | |
| | Source DE | gelatinized | | | | |
| | | corn starch | | | | |
| 11 | First and | Corn starch | Powdered corn | Bentonite | Gellan | Powdered corn syrup |
| | Second | and pre- | syrup | fines | gum | |
| | Source DE | gelatinized | | | | |
| | | corn starch | | | | |
| 12 | First and | Corn starch | Powdered corn | Bentonite | Gellan | Powdered corn syrup |
| | Second | and pre- | syrup | fines | gum | or MCC |
| | Source DE | gelatinized | | | | |
| | | corn starch | | | | |
| 13 | First and | Corn starch | Powdered corn | Bentonite | Gellan | Powdered corn syrup |
| | Second | and pre- | syrup | fines | gum | or CMC |
| | Source DE | gelatinized | | | | |
| | | corn starch | | | | |
| 14 | First and | Corn starch | Powdered corn | Bentonite | Gellan | Lignosulfonate or |
| | Second | and pre- | syrup | fines | gum | powdered corn syrup |
| | Source DE | gelatinized | | | | |
| | | corn starch | | | | |
| Example | First and | CMC and | CMC | Bentonite | CMC | CMC |
| 3.1 | Second | pre- | | fines or | | |
| | Source DE | gelatinized | | bentonite | | |
| | | corn starch | | fines and | | |
| | | | | DE | | |
| Example | First and | CMC, corn | CMC | Bentonite | CMC or | CMC |
| 3.2 | Second | starch and | | fines | CMC and | |
| | Source DE | pre- | | | cornstarch | |
| | | gelatinized | | | | |
| | | corn starch | | | | |

### Trial 1

### Recipe for Part A:

a water citric acid mixture was made by dissolving 75 grams of citric acid in 304 grams of water
59.0 grams of First Source DE, 59.0 grams of Second Source DE, 8 grams of corn starch, and approximately 113.5 grams of citric water, yielding a 38% moisture mixture.

### Recipe for Part B:

Bentonite mixed with Xanthan gum (at a rate of 7.2% of the dry bentonite-xanthan gum mixture by mass) and tap water were added to preformed granules to form a bentonite/gum coated granule. The coating mixture was targeted at 1 part bentonite-xanthan dry mass, to 1 part wet DE core granule mass.

Results. Part A. The granules formed nicely on the sieve faces with the corn starch binder and produced reasonably consistent and easy to work with granules, however there was a significant fraction that agglomerated beyond the 2 mm threshold implying the sample may have been a little too wet. This larger than 2 mm fraction was set aside and dried, and had a final density of 480 kg/m³ or 30 pounds per cubic foot. Part B. The 1 to 2 mm DE granule fraction was coated in the drum mixer in two half batches, and the amount of bentonite and xanthan gum rolled onto the original granules along with the resulting granule sizes are shown in Table 1.2. The mass fractions of these amounts are shown in Table 1.3. The produced Part A granules adhered well to the Part B coating. The densities measured in Table 1.4 indicate that none of the material was purely bentonite so the coating process was effective.

TABLE 1.2
Masses of materials added to the original granules and the resulting granule proportions.

| | | | | Core | Shell | | | |
|---|---|---|---|---|---|---|---|---|
| | Wet mass | Total | | Starch | Gum | Larger | | Less |
| | of DE | Water | Bentonite | Binder | Binder | than | 1.4 mm to | than |
| Sample/Fraction | granule | Added | Added | Added | Added | 2.36 mm | 2.36 mm | 1.4 mm |
| 1.0 mm to | 108.8 g | 67.8 g | 101.8 g | 3.6 g | 8.0 g | 161.8 g | 50.9 g | 8.8 g |
| 2 mm DE | | | | | | | | |

TABLE 1.3
Fractions of composition for the formed final granules and size fractions
of the final granules across the range of original DE granules sizes.

| | | | | Fraction | Fraction | | | |
|---|---|---|---|---|---|---|---|---|
| | | | Fraction | of final | of final | | | |
| | | Fraction | of final | granule | granule | | | |
| | Fraction | of final | granule | wet mass | wet mass | | | |
| Starting | of final | granule | wet mass | that is | that is | Larger | | Less |
| DE granule | granule | that is | that is | Core | Shell | than | 1.4 mm to | than |
| description | that is DE | water | bentonite | Binder | Binder | 2.36 mm | 2.36 mm | 1.4 mm |
| 1.0 mm to | 36.3% | 23.7% | 35.5% | 1.27% | 2.79% | 56.5% | 17.8% | 3.1% |
| 2 mm DE | | | | | | | | |

Table 1.4 reveals the final dry bulk densities of the granules formed from the bentonite coated DE cores. The bulk densities were 39 to 40 lbs/ft³ in the target size range. The dry masses coupled with the calculated water added imply that 83% of the water evaporated during drying suggesting the final granules had a final moisture content around 7%.

TABLE 1.4
Dry granule fraction, bulk densities based on sizes produced
and a general assessment of granule integrity or robustness.

| | | | | | Fraction | | |
|---|---|---|---|---|---|---|---|
| | | | | | of final | | |
| | Fraction of | Fraction of | Fraction of | Fraction of | granule | | |
| | final granule | final granule | final granule | final granule | that is | | |
| Starting | that is core | that is shell | that is DE | that is citric | bentonite | Larger | |
| DE granule | binder on a | binder on a | on a dry | acid on a | on a dry | than | 1.4 mm to |
| description | dry basis | dry basis | basis | dry basis | basis | 2.36 mm | 2.36 mm |
| 1.0 mm to | 1.9% | 4.3% | 33.8% | 5.5% | 54.5% | 561.2 kg/m³ | 582.4 kg/m³ |
| 2 mm DE | | | | | | | |
| | | | | | | 38.9 lbs/ft³ | 40.4 lbs/ft³ |

| | |
|---|---|
| Granule | some hard but crush |
| integrity | |

TABLE 1.5
Clumping strengths from the four tested samples.

| | less than | | | | Large | |
|---|---|---|---|---|---|---|
| | 2.36 mm | | | | Clump | |
| | after | 2.36 mm | 1.4 to | Clump | after | Clumping |
| Granule Source | drying | plus | 2 mm | Removed | drop | Strength |
| 1.0 mm to 2.0 mm DE core with shell | 36.0 g | | | 20.6 g | 19.7 g | 95.6% |
| 1.0 mm to 2.0 mm DE core with shell | | 48.5 g | | 19.9 g | 19.1 g | 96.0% |
| 1.0 mm to 2.0 mm DE core with shell | | | 46.6 g | 20.0 g | 19.4 g | 96.9% |
| 2.0 mm plus DE core without shell | | 35.0 g | | 8.5 g | 0.5 g | 5.9% |

As can be seen in Table 1.5, the clumping test produced very good results for the bentonite-xanthan gum coated granules.

### Trial 2—Effects of Low-Temperature Drying

One challenge with using gum polymers as a binder is a relatively low drying temperature requirement. Literature suggests that the xanthan gum polymer structure begins to break down at temperature in excess of 80° C. (Itohan Eiroboyi, S. S. Ikiensikimama, Thermal Stability of Bio-Polymers and their Blends, Nigerian Journal of Technological Development, Vol. 19, No. 1, March 2022), so verification of permissible drying temperature ranges was investigated.

### Recipe for Part A:

a water citric acid mixture was made by dissolving 75 grams of citric acid in 304 grams of water
59.0 grams of First Source DE, 59.0 grams of Second Source DE, 14 grams of corn starch, and approximately 118.9 grams of citric water, yielding a 38% moisture mixture.

### Recipe for Part B:

Bentonite mixed with shell coating binder (at a rate of 7.2% of the dry bentonite-binding gum mixture by mass) and tap water were added to preformed granules to form a bentonite/gum coated granule. In this test Xanthan gum alone was used as the shell binder.
The coating mixture was targeted at 0.8 part bentonite-xanthan dry mass, to 1 part wet DE core granule mass.

Results. Part A. The larger than 2 mm fraction was set aside and dried along with a small sample of the 1-2 mm fraction and had final dry densities of 447 kg/m³ or 28 pounds per cubic foot and 424 kg/m³ or 26.5 pounds per cubic foot.

TABLE 2.1
Size fractions of the core granules formed with
the hand mixer using corn starch binder.

| | Larger than | 1.0 mm | Less than |
|---|---|---|---|
| Sample/Fraction | 2.0 mm | to 2 mm | 1.0 mm |
| Wet mass | 66.6 g | 130.7 g | 5.6 g |
| Wet Mass Fractions | 32.8% | 64.4% | 2.7% |
| Dry Density | 447.7 kg/m³ | 424.0 kg/m³ | N/A |

Part B. The 1 to 2 mm DE granule fraction listed in Table 2.1 was coated in the drum mixer in two batches. The batches had different drying criteria (in ambient air and in the oven at a maximum of ˜75° C. The purpose was to find a reasonable drying temperature that did not affect the xanthan gum polysaccharides such that clumping was impaired and determine if the higher corn starch loading in the core DE granule improved hardness. The batches were labelled as
1A1—1 mm to 2.0 mm DE core with Xanthan shell ambient temp air dried
1B1—1 mm to 2.0 mm DE core with Xanthan shell 75° C. oven dried
   The amount of bentonite and gum rolled onto the original granules along with the resulting granule sizes are shown in Table 2.2. The mass fractions of these amounts are shown in Table 2.3. The produced granules adhered well to the bentonite. Visually it appears that the majority of the bentonite powder rolled up on the seed granules and the coated granules appeared to be quite consistent in size and quality. The densities measured in Table 2.4 indicate that the material coating process was successful.

TABLE 2.2
Masses of materials added to the original granules and the resulting granule proportions.

| | | | | Core | Shell | | Not | |
|---|---|---|---|---|---|---|---|---|
| | Wet mass | Total | | Starch | Gum | Larger | Sieved ~1.4 | Less |
| | of DE | Water | Bentonite | Binder | Binder | than | mm to | than |
| Sample/Fraction | granule | Added | Added | Added | Added | 2.36 mm | 2.36 mm | 1.4 mm |
| 1A.1 1.0 mm to | 45.0 g | 26.5 g | 33.4 g | 2.51 g | 2.6 g | 0.0 g | 87.4 g | 0.0 g |
| 2 mm DE | | | | | | | | |
| 1B.1 1.0 mm to | 45.0 g | 26.7 g | 33.4 g | 2.51 g | 2.6 g | 0.0 g | 87.2 g | 0.0 g |
| 2 mm DE | | | | | | | | |

TABLE 2.3
Fractions of composition for the formed final granules and size fractions
of the final granules across the range of original DE granules sizes.

| | | | | Fraction | Fraction | | | |
|---|---|---|---|---|---|---|---|---|
| | | | Fraction | of final | of final | | | |
| | | Fraction | of final | granule | granule | | | |
| | Fraction | of final | granule | wet mass | wet mass | | Not | |
| Starting | of final | granule | wet mass | that is | that is | Larger | Sieved ~1.4 | Less |
| DE granule | granule | that is | that is | Core | Shell | than | mm to | than |
| description | that is DE | water | bentonite | Binder | Binder | 2.36 mm | 2.36 mm | 1.4 mm |
| 1A.1 1.0 mm | 38.6% | 24.7% | 31.1% | 2.34% | 2.42% | 0.0% | 81.3% | 0.0% |
| to 2 mm DE | | | | | | | | |
| 1B.1 1.0 mm | 38.6% | 24.8% | 31.0% | 2.33% | 2.41% | 0.0% | 81.0% | 0.0% |
| to 2 mm DE | | | | | | | | |

Table 2.4 reveals the final dry bulk densities of the granules formed from the bentonite coated DE cores. The bulk densities were ˜37 lbs/ft³ in the target size range. Visually it appeared the particles were so consistent in the target size range that sieving post drum coating was not done, and the coating production process generated a nice mixture of granules that appear very suitable for a diverse litter.

TABLE 2.4
Dry granule fraction, bulk densities based on sizes produced and a general assessment of granule integrity of robustness.

| | | | | | Fraction | | | | |
|---|---|---|---|---|---|---|---|---|---|
| | | | Fraction | | of final | | | | |
| | Fraction of | Fraction of | of final | Fraction of | granule | Fraction of | | | |
| | final granule | final granule | granule | final granule | that is | core granule | Not | | |
| Starting | that is core | that is shell | that is | that is citric | bentonite | that is core | Sieved ~1.4 | | Less |
| DE granule | binder on a | binder on a | DE on a | acid on a | on a dry | binder on a | mm to | | than |
| description | dry basis | dry basis | dry basis | dry basis | basis | dry basis | 2.36 mm | | 1.4 mm |
| 1A.1 1.0 mm | 3.7% | 3.8% | 36.9% | 6.2% | 49.4% | 7.9% | 534.5 | kg/m³ | |
| to 2 mm DE | | | | | | | | | |
| | | | | | | | 37.1 | lbs/ft³ | |
| Granule integrity | | | | | | | Firmer but still crush | | |
| 1B.1 1.0 mm | 3.7% | 3.8% | 36.9% | 6.2% | 49.4% | 7.9% | 540.7 | kg/m³ | |
| to 2 mm DE | | | | | | | | | |
| | | | | | | | 37.5 | lbs/ft³ | |

| | |
|---|---|
| Granule integrity | Firmer but still crush |

TABLE 2.5
Clump strength calculation results for the ambient temp air dried and
oven dried samples with a xanthan gum shell binder compositions.

| | Not Sieved | Weight of | Large | |
|---|---|---|---|---|
| | ~1.4 mm | Clump | Clump | Clumping |
| Granule Source | to 2.36 mm | Removed | After Drop | Strength |
| 1.0 mm to 2.0 mm DE | 59.3 g | 19.0 g | 18.5 g | 97.4% |
| core with Xanthan shell | | | | |
| air dried at ambient temp | | | | |
| 1.0 mm to 2.0 mm DE | 57.2 g | 18.6 g | 17.8 g | 95.7% |
| core with Xanthan shell | | | | |
| 65 to 75° C. oven dried | | | | |

The results of this example demonstrate that a low drying temperature as used that ranged from 65° C. to 77° C. did not appear to affect the quality of the xanthan gum binder since performance with the ambient dried sample was nearly identical.

### Trial 3—Addition of Hardening Binder to Core

The purpose of this trial was to ascertain if a very controlled drying process (105° C.) for 70 minutes would reduce the negative effects of clumping on the CMC shell. Additionally corn syrup was tested as a hardening agent binder in the core.

### Recipe for Part A:

A water citric acid mixture plus corn syrup was made by dissolving 50 grams of citric acid in 304 grams of water and then adding 65 grams of a relatively pure corn syrup to the water acid mixture, which readily dissolved in the acid water.
59 grams of First Source DE, 59 grams of Second Source DE, 12 grams of corn starch, and approximately 115.7 grams of syrup-citric water, yielding a 32.5% moisture mixture.

### Recipe for Part B:

Bentonite mixed with shell coating binder to coat the exterior of the produced smaller granules. The amount of shell material supplied was 85% of the wet mass of the core material. The shell material was 93% bentonite and 7% binder by mass. In this Trial a mixture of CMC and corn starch (92% CMC, 8% corn starch) was used as the binder for the shell.

Results. Part A. The granules formed nicely on the sieve faces with the corn starch binder and produced reasonably consistent and easy to work with granules, and the consistency was such that material that would pass the 1 mm sieve was very minimal and only a few percent of the produced material was over the target size (Table 3.1).

TABLE 3.1
Size fractions of the DE granules formed with the hand
mixer using corn starch binder and syrup.

| | Larger | 1.0 mm | Less |
|---|---|---|---|
| Sample/Fraction | than 2.0 mm | to 2 mm | than 1.0 mm |
| Wet mass | 52.8 g | 164.6 g | 12.6 g |
| Wet Mass Fractions | 23.0% | 71.6% | 5.5% |

Part B. The 1 to 2 mm DE granule fraction listed in Table 3.1 was coated in the drum mixer in three batches and then combined before drying. The drying was conducted in a precision oven set at 105° C. and then material was spread out on two trays and only dried for 70 minutes to simulate something similar to commercial drying operations. The intent was to not remove all the moisture from the material, but a post drying moisture content measurement revealed that only 0.3% moisture remained, which implies that the 105° C. temperature is not detrimental to the CMC. (Table 3.2 and Table 3.3).

TABLE 3.2
Masses of materials added to the original granules and the resulting granule proportions.

| | | | | Core | | | Not | |
|---|---|---|---|---|---|---|---|---|
| | Wet mass | Total | | Starch | Shell | Larger | Sieved ~1.4 | Less |
| | of DE | Water | Bentonite | Binder | Binder | than | mm to | than |
| Sample/Fraction | granule | Added | Added | Added | Added | 2.36 mm | 2.0 mm | 1.4 mm |
| 1-2 mm with | 165.0 g | 130.0 g | 130.4 g | 7.67 g | 9.8 g | 0.0 g | 313.0 g | 0.0 g |
| CMC | | | | | | | | |

TABLE 3.3
Fractions of composition (on a wet basis) for the formed final granules.

| | | | | Fraction | Fraction | | | |
|---|---|---|---|---|---|---|---|---|
| | | | Fraction | of final | of final | | | |
| | | Fraction | of final | granule | granule | | | |
| | Fraction | of final | granule | wet mass | wet mass | | Not | |
| Starting | of final | granule | wet mass | that is | that is | Larger | Sieved ~1.4 | Less |
| DE granule | granule | that is | that is | Core | Shell | than | mm to | than |
| description | that is DE | water | bentonite | Binder | Binder | 2.36 mm | 2.0 mm | 1.4 mm |
| 1-2 mm with | 35.5% | 29.9% | 30.0% | 1.76% | 2.26% | 0.0% | 70.7% | 0.0% |
| CMC | | | | | | | | |

Table 3.4 reveals the final dry bulk densities of the granules formed from the bentonite coated DE cores and the dry weight fraction of materials added. The bulk densities were ˜35 lbs/ft³ in the target size range. The final particles are consistent enough in the target size range that post coating sieving is not required although the final size seems smaller than desirable.

TABLE 3.4
Dry granule fraction, bulk density and a general assessment of granule integrity or robustness.

| | | | | | | | Fraction of | | |
|---|---|---|---|---|---|---|---|---|---|
| | Fraction of | | | | Fraction of | | core granule | | |
| | final granule | Fraction of | Fraction of | Fraction of | final granule | Fraction of | that is core | | |
| | that is core | final granule | final granule | final granule | that is | final granule | binder | Not | |
| Starting | binder (corn | that is shell | that is DE | that is citric | bentonite | that is syrup | (overall) | Sieved ~1.4 | Less |
| DE granule | starch) on | binder on a | on a dry | acid on a | on a dry | on a dry | on a dry | mm to | than |
| description | a dry basis | dry basis | basis | dry basis | basis | basis | basis | 2.0 mm | 1.4 mm |
| 1-2 mm | 2.9% | 3.8% | 35.3% | 3.4% | 49.9% | 4.8% | 16.7% | 507.4 kg/m³ | |
| with CMC | | | | | | | | | |
| Ambient | | | | | | | | 35.2 lbs/ft³ | |
| Air Dried | | | | | | | | | |

| | |
|---|---|
| Granule | crushes easily |
| integrity | |

TABLE 3.5
Clump strength calculation results for the ambient temp air dried and oven
dried samples with CMC and corn starch shell binder compositions.

| | Not Sieved | Weight of | Large | |
|---|---|---|---|---|
| | ~1.4 mm | Clump | Clump | Clumping |
| Granule Source | to 2.36 mm | Removed | After Drop | Strength |
| 1-2 mm with CMC and | 48.5 g | 17.7 g | 17.2 g | 97.1% |
| dried at 105° C. | | | | |

These clump strength data reveal that the granule matrix was very good for clumping and the CMC was not impacted by 105° C. over 70 minutes of drying which reduce moisture content 0.3%. A follow up test with the small sample dried at 105° C. overnight for moisture content indicated that the clumping quality was not significantly affected.

### Trial 4—Adjusting Particle Size by Adjusting Liquid Viscosity

### Recipe for Part A:

A water citric acid mixture was made by dissolving 50 grams of citric acid in 304 grams of water.
29.5 grams of First Source DE, 29.5 grams of Second Source DE, 4 grams of corn starch, 6 grams of MCC and approximately 61.25 grams of citric water.

### Recipe for Part B:

Bentonite mixed with shell coating binder to coat the exterior of the produced smaller granules. The amount of shell material supplied was 85% of the wet mass of the core material. The shell material was 93% bentonite and 7% CMC binder by mass for one sample and a second sample was 92% bentonite and 8% binder. In the second sample the binder was 67% MCC and 33% MCC. Final mixes were:
   For sample A that was added to 38 grams of cores granules, 30 g bentonite plus 2.3 grams of CMC and 14.4 grams of tap water made the coating.
   For sample B that was added to 38 grams of core granules, 30 g bentonite plus 2.0 grams of CMC, 1.4 grams of MCC and 14.6 grams of tap water made the coating.

Results. Part A. Small granules were generated which has become prevalent with trials with reduced acid water strength. The density was 404 kg/m³ of 28 lbs per ft³. Part B: The coated and dried small granules were not particular strong and rubbed to dust rather easily. The final dry density was good 442 kg/m³ of 31 lbs per ft³ for sample A and 460 kg/m³ of 32 lbs per ft³ for sample B.

### Trial 5—Adjusting Particle Size by Adjusting Liquid Viscosity

The purpose of this trial was to test the effect of increasing the acid water viscosity on the core granule formation. With the ongoing reduction in citric acid content the core granules being produced were considerably and consistently smaller than previous work without explanation. Without being bound, it was speculated that the minor change in acid water viscosity was the influencing factor. In this trial a small amount of pre-gelatinized corn starch powder was added to the acid water to increase its viscosity when producing the absorbent core. MCC as a hardening agent binder in the core was also tested.

### Recipe for Part A:

A water citric acid mixture was made by dissolving 50 grams of citric acid in 304 grams of water and to this mixture 1.6 grams of pre-gelatinized corn starch was added to increase the viscosity.
29.5 grams of First Source DE, 29.5 grams of Second Source DE, 2 grams of corn starch, 4 grams of MCC and approximately 62.2 grams of viscous citric water.

### Recipe for Part B:

Bentonite mixed with shell coating binder to coat the exterior of the produced smaller granules. The amount of shell material supplied was 85% of the wet mass of the core material. The shell material was 92% bentonite and 8% CMC binder by mass for one sample and in a second sample the 8% binder was a mixture of 50% CMC, 25% MCC and 25% Guar Gum. Final mixes were:
   For sample A that was added to 40 grams of cores granules, 31.28 g bentonite plus 2.72 grams of CMC and 18.5 grams of tap water made the coating.
   For sample B that was added to 40 grams of core granules, 31.28 g bentonite plus 1.36 grams of CMC, 0.68 grams of MCC, 0.68 grams of guar gum and 20.4 grams of tap water made the coating.

Results. Part A. Larger granules were readily generated and formed abruptly in the mixing bowl when the moisture threshold was reached. In general, a large fraction of oversize granules were produced, and separation was required to recover granules suitable for Part B. The post drying density of the core granules was 419 kg/m³ of 29 lbs per ft³ and these core granules were harder than previous trials but still crushable. Part B. The coated and dried small granules were noticeably harder and more robust. Additionally, it was observed the density of the product was considerably higher than normal. Table 5.1 shows the results for the density, hardness and clumping strength.

TABLE 5.1
Density, hardness and clumping strength measured
on the two differently coated samples.

| Material/ | | Hardness | | | Clumping |
|---|---|---|---|---|---|
| Parameter | Density | # Soft | # Med | # Very Hard | Strength |
| Sample A | 577.2 kg/m³ | 0 | 1 | 9 | 17.94 g clump |
| | 40.1 lbs/ft³ | | | | 66.3% |
| Sample B | 600.0 kg/m³ | 1 | 2 | 7 | 17.70 g clump |
| | 41.6 lbs/ft³ | | | | 67.2% |

The results of this trial reveal the effect that the viscosity of the acid water used in the core granule preparation has on the size of the cores granules produced. While the target size was overshot in this trial the impact of the small amount of pre-gelatinized corn starch shows that increasing viscosity of the solution added to granulate Part A can be used to control the core granule size. Despite the large size of the final granules the clumping performed rather well, and the results were good considering some of the exterior granules releasing made up the bulk of lost clump mass. A significant improvement in hardness was measured but this did come with a additional density. It would appear the MCC has a positive effect on hardness.

### Trial 6—Controlling Core Particle Size Through Liquid Viscosity

### Recipe for Part A:

A water citric acid mixture was made by dissolving 50 grams of citric acid in 304 grams of water and to this mixture 0.9 grams of pre-gelatinized corn starch was added to increase the viscosity.
29.5 grams of First Source DE, 29.5 grams of Second Source DE, 2 grams of corn starch, 4 grams of MCC and approximately 62.2 grams of viscous citric water.

### Recipe for Part B:

Bentonite mixed with shell coating binder to coat the exterior of the produced smaller granules. The amount of shell material supplied was 85% of the wet mass of the core material. The shell material was 92% bentonite and 8% CMC binder by mass for one sample and in a second sample the 8% binder was a mixture of 75% CMC and 25% MCC. After clump testing it was found that the CMC binder amount was not adequate so an additional coating of CMC was put on the previous prepared granules at a rate of 3.5% of the dry matter mass. Final mixes were:
   For sample A materials that were added to 54.8 grams of cores granules included; 40.36 g bentonite plus 3.51 grams of CMC and 15 grams of tap water made the coating.
   For sample B materials that were added to 54.8 grams of cores granules included; 40.36 g bentonite plus 2.63 grams of CMC, 0.87 grams of MCC, and 15.6 grams of tap water made the coating.
   The 112 grams from the previous 2 samples was blended together and 4 grams of CMC was added in conjunction with 21 grams of tap water. These revised granules were then re-dried.

Results. Part A. Ideal size core granules were readily generated and readily formed in the mixing bowl and on a shaken screen when the moisture threshold was reached. In general, a small amount oversize granules were produced, and most oversize material was brushed through a 2.36 mm screen, so no real separation was required to recover granules suitable for Part B. Part B. The coated granules were close to ideal size for cat litter and once dried at 102° C. or lower, these granules were again noticeably harder relative to main previous trials and more. Table 6.1 shows the results for the density, hardness and clumping strength. Again, it was observed the density of the product was higher than previous trials, but not problematically higher.

TABLE 6.1
Density, hardness and clumping test results.

| Material/ | | | Hardness | | | Clumping | Clumping Strength |
|---|---|---|---|---|---|---|---|
| Parameter | Density | | # Soft | # Med | # Very Hard | Strength | (revised sample) |
| Sample A | 546.3 | kg/m³ | 1 | 3 | 6 | 16.75 g clump | 19.80 g clump |
| | 37.9 | lbs/ft³ | | | | 10.1% | |
| Sample B | 575.6 | kg/m³ | 1 | 3 | 8 | No Clump | 96.0% |
| | 39.9 | lbs/ft³ | | | | | |

The results from this trial further validate that the viscosity of the citric water blend can be used to control the granule size produced quite specifically.

Trial 7—Further Adjusting Viscosity of Liquid when Forming Core Granules

### Recipe for Part A:

A water citric acid mixture was made by dissolving 65.5 grams of citric acid in 233.3 grams of water and to this mixture 1.18 grams of pre-gelatinized corn starch was added to increase the viscosity. At the onset of this trial 214.7 grams of the original acid-starch water formulation was remaining, and another 0.35 grams of pre-gelatinized corn starch was added to the mixture. Only a portion of this liquid was used to form the core granules.
29.5 grams of First Source DE, 29.5 grams of Second Source DE, 2 grams of corn starch, 6 grams of powdered corn syrup and 40.0 grams of the viscous acid water were mixed together to form a dust free damp powder. Once homogenous, 15.9 grams of tap water was added to bring the mixture to the right consistency for granule formation. Ultimately it was found this was too much extra starch a large amount of larger granules were formed and so only enough reasonable sized granules were salvaged to generate one sample for Part B.

### Recipe for Part B:

Bentonite mixed with shell coating binder to coat the exterior of the produced smaller granules. The amount of shell material supplied was 80% of the wet mass of the core material. The shell material was 90% bentonite and 10% Gellan Gum binder by mass. The final mix was:
   For sample A, 50 grams of core granules were formed and 36 g of bentonite plus 4 grams of Gellan Gum and 18.1 grams of tap water were added as the coating.

Results. Part A. The core granules generated and formed in the mixing bowl and on the shaken screen when the moisture threshold was reached were too large. Without being bound, it is believed that too much pre-gelatinized starch was added, and further viscosity adjustment should be made. Part B. The core granules coated easily and produced reasonable granules but the granules were slightly oversized. Once dried at ˜102° C. these final granules were a mixture of soft and hard granules further implying the powdered corn syrup was useful as a hardener in the core. Table 7.1 shows the results for the density, hardness and clumping strength. The density of the product measured in this trial is on the upper edge of the acceptable range. The results from the table again suggest Gellan Gum binder is an excellent clumping binder, especially considering the quality of the clump with these slightly oversized granules.

TABLE 7.1
Density, hardness and clumping test results.

| Material/ | | Hardness | | | Clumping |
|---|---|---|---|---|---|
| Parameter | Density | # Soft | # Med | # Very Hard | Strength |
| Sample A | 564.7 kg/m³ | 4 | 4 | 2 | 17.95 g clump |
| (Gellan) | 39.2 lbs/ft³ | | | | 95.5% |

### Trial 8—Effect of Concentrated Citric Acid Addition

The purpose of this trial was to examine the effect of reducing the strength of the concentrated acid water pre-gelatinized starch viscous liquid in combination with the plain water on the core granule formation with powdered corn syrup as the hardening agent binder in the core. It was hypothesized that this concentrated acid addition was impacting the binding the granule hardness properties and since the pre-gelatinized starch amount needed dilution the entire acid was diluted. In the shell the performance of Gellan Gum was tested alone and in combination with more powdered corn syrup, which was intended to interact with the core and hopefully improve overall final granule hardness.

### Recipe for Part A:

The water citric acid mixture that was previously made was further diluted such that this final composition was in use. (38 grams of citric acid in 225.6 grams of water and to this mixture 0.97 grams of pre-gelatinized corn starch was added to increase the viscosity). Only a portion of this 264.6 grams of liquid was used to form the core granules.
29.5 grams of First Source DE, 29.5 grams of Second Source DE, 2 grams of corn starch, 5 grams of powdered corn syrup and 40.15 grams of the viscous acid water were mixed together to form a dust free damp powder. Once homogenous, 11.14 grams of tap water was added to bring the mixture to the right consistency for granule formation.

### Recipe for Part B:

Bentonite mixed with shell coating binder to coat the exterior of the produced smaller granules. The amount of shell material supplied was 80% of the wet mass of the core material. The shell material was 90% bentonite and 10% Gellan Gum binder by mass for one sample and in a second sample the mixture was 85% bentonite, 10% Gellan Gum binder and 5% powdered corn syrup for a hardener. Final mixes were:
   For sample A, 50 grams of core granules were formed and 36 g of bentonite plus 4 grams of Gellan Gum and 19.9 grams of tap water were added as the coating.
   For sample B, 50 grams of core granules were formed and 34 g of bentonite plus 4 grams of Gellan Gum mixed with 2 grams of corn syrup powder along with 18.68 grams of tap water were added as the coating.

Results. Part A. The viscosity adjustment appeared reasonable since consistent properly sized granules were generated without much effort. Part B. The core granules coated easily and produced a reasonable target sized final granule for drying. Once dried at ˜102° C. these final granules that were just Gellan Gum coated were mostly soft with some medium harness granules while the Gellan Gum combined with corn syrup produced mostly very hard granules, showing the effect the powdered syrup binder had (Table 8.1). Table 8.1 shows the results for the density, hardness and clumping strength. The clumping action seemed consistent whether or not the corn syrup powder was in the shell, but the syrup clearly contributed to the granule hardness.

TABLE 8.1
Density, hardness and clumping test results.

| Material/ | | Hardness | | | Clumping |
|---|---|---|---|---|---|
| Parameter | Density | # Soft | # Med | # Very Hard | Strength |
| Sample A | 570.7 kg/m³ | 6 | 4 | 0 | 22.79 g clump |
| (Gellan) | 39.6 lbs/ft³ | | | | 96.0% |
| Sample B | 557.1 kg/m³ | 1 | 5 | 4 | 20.87 g clump |
| (Gellan/ | 38.7 lbs/ft³ | | | | 95.8% |
| Corn Syrup) | | | | | |

Trial 9—Gellan Gum Binder with and without MCC in Shell

### Recipe for Part A:

The water citric acid mixture that was previously made was further diluted such that this final composition was in use. (38 grams of citric acid in 225.6 grams of water and to this mixture 0.97 grams of pre-gelatinized corn starch was added to increase the viscosity). Only a portion of this 264.6 grams of liquid was used to form the core granules.
59 grams of Second Source DE, 2 grams of corn starch, 5 grams of powdered corn syrup and 40 grams of the viscous acid water were mixed together to form a dust free damp powder. Once homogenous, only 1.95 grams of tap water was added to bring the mixture to the right consistency for granule formation. This formulation produced a crumb granule that was easy to work with and needed little granulation effort on the sieve before the drum in Part B.

### Recipe for Part B:

Bentonite mixed with shell coating binder to coat the exterior of the produced smaller granules. The amount of shell material supplied was 80% of the wet mass of the core material. The shell material was 90% bentonite and 10% Gellan Gum binder by mass for one sample and in a second sample the mixture was 85% bentonite, 10% Gellan Gum binder and 5% MCC for a hardener. Final mixes were:
   For sample A, 50 grams of core granules were formed and 36 g of bentonite plus 4 grams of Gellan Gum and 19.22 grams of tap water were added as the coating.
   For sample B, 50 grams of core granules were formed and 34 g of bentonite plus 4 grams of Gellan Gum mixed with 2 grams of MCC along with 20.48 grams of tap water were added as the coating.

Results. Part A. The viscosity adjustment appeared reasonable since consistent properly sized granules were generated without much effort. Part B. The core granules coated easily and produced a reasonable target size final granule for drying, although a portion were somewhat oversized since the viscosity was not optimized for this material. Once dried at ˜102° C. these final granules that were just Gellan Gum coated were mostly hard with some medium harness granules while the Gellan Gum combined with MCC produced appeared to produce some harder granules, suggesting the MCC binder potentially increased hardness (Table 9.1). Table 9.1 shows the results for the density, hardness and clumping strength. The results from the table once again suggest Gellan Gum binder is an excellent clumping binder and was able to even hold the large granules produced in this trial together. It should be noted that the clumping scores are highly influence by only a few large granules dislodging and as seen in the figure the clump was still very much intact. While the sample with MCC in the shell seemed to have higher hardness, the granule size has normally influenced this as well, but ten to twenty more typical sized granules were used to assess hardness so the granule size influence on results should be mostly mitigated. Without being bound, it is uncertain if the MCC was detrimental to clumping strength.

TABLE 9.1
Density, hardness and clumping test results.

| Material/ | | Hardness | | | Clumping |
|---|---|---|---|---|---|
| Parameter | Density | # Soft | # Med | # Very Hard | Strength |
| Sample A | 618.4 kg/m³ | 2 | 3 | 5 | 21.98 g clump |
| (Gellan) | 42.9 lbs/ft³ | | | | 93.3% |
| Sample B | 623.3 kg/m³ | 2 | 2 | 6 | 22.73 g clump |
| (Gellan/ | 43.3 lbs/ft³ | | | | 87.6% |
| MCC) | | | | | |

Trial 10—Gellan Gum Binder with a Powdered Corn Syrup Shell and Reduced Acid Strength

The purpose of this trial was to examine the effect of reducing the amount of powdered corn syrup in the core and increasing it in the shell. Regular corn starch was increased in the core while in the shell the performance of Gellan Gum was tested in combination with two amounts of powdered corn syrup, which was meant to interact with the core and potentially improve overall final granule hardness.

### Recipe for Part A:

The water citric acid mixture that was previously made was further diluted such that this final composition was in use. (38 grams of citric acid in 225.6 grams of water and to this mixture 0.97 grams of pre-gelatinized corn starch was added to increase the viscosity. Only a portion of this 264.6 grams of liquid was used to form the core granules).
29.5 grams of First Source DE, 29.5 grams of Second Source DE, 4 grams of corn starch, 2 grams of powdered corn syrup and 40 grams of the viscous acid water were mixed together to form a dust free damp powder. Once homogenous 15.3 grams of tap water was added to bring the mixture to the right consistency for granule formation.

### Recipe for Part B:

Bentonite mixed with shell coating binder to coat the exterior of the produced smaller granules. The amount of shell material supplied was 80% of the wet mass of the core material. The shell material was 80% bentonite, 10% Gellan Gum and 10% powdered corn syrup binder by mass for one sample and in a second sample the mixture was 75% bentonite, 10% Gellan Gum binder and 15% powdered corn syrup for a hardener. Final mixes were:
   For sample A, 50 grams of core granules were formed and 32 g of bentonite plus 4 grams of Gellan Gum mixed with 4 grams of corn syrup powder along with 11.3 grams of tap water were added as the coating
   For sample B, 50 grams of core granules were formed and 30 g of bentonite plus 4 grams of Gellan Gum mixed with 6 grams of corn syrup powder along with 11.94 grams of tap water were added as the coating.

Results. Part A. The core granules generated and formed in the mixing bowl and on the shaken screen when the moisture threshold was reached were slightly too small. A slight viscosity adjustment (increase) may be needed when powdered corn syrup is reduced and replaced by regular corn starch. Part B. The core granules coated easily and produced a reasonable but slightly small target sized final granule for drying. Once dried at ˜102° C. the final granules that were just 10% coated with powdered corn syrup and even slightly on the small size, were predominately hard and were noticeably improved over the

Trial 8 Sample. The higher 15% addition of corn syrup resulted in mostly soft granules but the granule size was not ideal. Table 10.1 shows the results for the density, hardness and clumping strength. Interestingly with the reduction in powdered corn syrup in the core the density reduced from Trial 8, further confirming the effect this powder has on the core. The results from Table 10.1 once again suggest Gellan Gum binder is an excellent clumping binder. The clumping action seemed consistent regardless of the corn syrup powder amount in the shell, but the harder granules with less syrup did perform better on this occasion. In this trial it was observed that the clumps were quite deep and with a small diameter than many other trials.

TABLE 10.1
Density, hardness and clumping test results.

| Material/ | | Hardness | | | Clumping |
|---|---|---|---|---|---|
| Parameter | Density | # Soft | # Med | # Very Hard | Strength |
| Sample A | 519.3 kg/m³ | 1 | 2 | 7 | 16.90 g clump |
| (Gellan & | 36.0 lbs/ft³ | | | | 96.4% |
| Syrup) | | | | | |
| Sample B | 525.7 kg/m³ | 6 | 2 | 1 | 17.23 g clump |
| (Gellan/ | 36.5 lbs/ft³ | | | | 94.9% |
| more syrup) | | | | | |

Trial 11—Gellan Gum Binder with a Powdered Corn Syrup Shell

The purpose of this trial was to confirm the effect of reducing the amount of powdered corn syrup in the core and increasing it in the shell with a slightly larger target size granule. As in Trial 10, regular corn starch was increased in the core while in the shell the performance of powdered corn syrup was tested in combination with two amounts of Gellan gum, which was done to ascertain the influence of the Gellan gum. An attempt to adjust the final granule size was undertaken by increasing the amount of pre-gelatinized corn starch in the acid water mix by 10%.

### Recipe for Part A:

The water citric acid mixture that was previously made was used again and the base material was 38 grams of citric acid in 225.6 grams of water and to this mixture 0.97 grams of pre-gelatinized corn starch was added to increase the viscosity. This mixture represented a pre-gelatinized starch addition rate of 3.66 grams/Litre of acid water. This was increased to 4 grams per litre for this trial. Only a portion of this 264.6 grams of liquid was used to form the core granules.
29.5 grams of First Source DE, 29.5 grams of Second Source DE, 4 grams of corn starch, 2 grams of powdered corn syrup and 40 grams of the viscous acid water were mixed together to form a dust free damp powder. Once homogenous, 16.9 grams of tap water was added to bring the mixture to the right consistency for granule formation.

### Recipe for Part B:

Bentonite mixed with shell coating binder to coat the exterior of the produced smaller granules. The amount of shell material supplied was 80% of the wet mass of the core material. The shell material was 80% bentonite, 10% Gellan Gum and 10% powdered corn syrup binder by mass for one sample and in a second sample the mixture was 75% bentonite, ˜15% Gellan Gum binder and ˜10% powdered corn syrup for a hardener. Final mixes were:
   For sample A, 50 grams of core granules were formed and 32 g of bentonite plus 4 grams of Gellan Gum mixed with 4 grams of corn syrup powder along with 13.22 grams of tap water were added as the coating
   For sample B, 50 grams of core granules were formed and 32 g of bentonite plus 6 grams of Gellan Gum mixed with 4 grams of corn syrup powder along with 12.8 grams of tap water were added as the coating.

Results. Part A. The core granules generated and formed in the mixing bowl and on the shaken screen when the moisture threshold was reached were too small, although this was not totally obvious until the coated granules were produced. It is inferred without being bound that the viscosity increase was not optimal for this combination of ingredients. Part B. The core granules coated easily and produced a reasonable but slightly small target sized final granule for drying. Once dried at −102° C. it was obvious the final granules were on the small size, and predominately soft. Without being bound, these results seem to reinforce that there must be a reasonable granule size before the binders can introduce a hardening effect. Table 11.1 shows the results for the density, hardness and clumping strength. Again the Gellan Gum proved to be an excellent binder for clumping, but the small particle size made granule hardness data unreliable. The density remained consistent with this trial.

TABLE 11.1
Density, hardness and clumping test results.

| Material/ | | Hardness | | | Clumping |
|---|---|---|---|---|---|
| Parameter | Density | # Soft | # Med | # Very Hard | Strength |
| Sample A | 509.8 kg/m³ | 10 | 0 | 0 | 19.12 g clump |
| (Gellan & | 35.4 lbs/ft³ | | | | 96.2% |
| Syrup) | | | | | |
| Sample B | 528.9 kg/m³ | 10 | 0 | 0 | 19.50 g clump |
| (extra | 36.7 lbs/ft³ | | | | 96.4% |
| Gellan/syrup) | | | | | |

Trial 12—Gellan Gum Binder with a Powdered Corn Syrup and MCC Shell

The purpose of this trial was to confirm the effect of reducing the amount of powdered corn syrup in the core and increasing it in the shell with a slightly larger (target size granule). As in Trial 10 and 11, regular corn starch was increased in the core while in the shell the performance of powdered corn syrup was tested in combination with Gellan Gum. The test was also conducted with MCC in the shell instead of corn syrup to verify if MCC improved granule hardness. An attempt to manipulate the final granule size was again undertaken by increasing the concentration of pre-gelatinized corn starch in the acid water mix by 62% from the previous trial.

### Recipe for Part A:

The water citric acid mixture that was previously made was used again and the base material was, 38 grams of citric acid in 225.6 grams of water and to this mixture ˜1.72 grams of pre-gelatinized corn starch was added to increase the viscosity. This mixture represented a pre-gelatinized starch addition rate of 6.5 grams/Litre of final acid water. This was a 62% concentration increase from the previous trial rate of 4 grams per litre. Only a portion of this 264.6 grams of liquid was used to form the core granules.
29.5 grams of First Source DE, 29.5 grams of Second Source DE, 4 grams of corn starch, 2 grams of powdered corn syrup and 40 grams of the viscous acid water were mixed together to form a dust free damp powder. Once homogenous ˜16 grams of tap water was added to bring the mixture to the right consistency for granule formation.

### Recipe for Part B:

Bentonite mixed with shell coating binder to coat the exterior of the produced smaller granules. The amount of shell material supplied was 80% of the wet mass of the core material. The shell material was 80% bentonite, 10% Gellan Gum and 10% powdered corn syrup binder by mass for one sample and in a second sample the mixture was 80% bentonite, 10% Gellan Gum binder and 10% MCC for a hardener. Final mixes were:
   For sample A, 50 grams of core granules were formed and 32 g of bentonite plus 4 grams of Gellan Gum mixed with 4 grams of corn syrup powder along with 16.9 grams of tap water were added as the coating.
   For sample B, 50 grams of core granules were formed and 32 g of bentonite plus 4 grams of Gellan Gum mixed with 4 grams of MCC along with 22 grams of tap water were added as the coating.

Results. Part A. The core granules generated and formed in the mixing bowl and on the shaken screen when the moisture threshold appeared ideal. The viscosity adjustment (increase) undertaken with the extra gel starch addition was thus about right to generate core granules. Part B. The core granules coated easily and produced a reasonable sized final granule for drying. Once dried at −102° C. it was obvious the final granules were all near target size for Sample A but Sample B with the MCC produced some oversized granules. It should be noted that the MCC sample required considerably more water during the coating process. Table 12.1 shows the results for the density, hardness and clumping strength. The hardness results experience in Trial 10 did not replicate well with this trial with no real hard granules being produced. The MCC also appeared to contribute to the creation of a wide flatter clump relative to the others that are deeper and smaller in diameter. The density remained rather consistent with this trial although the MCC use did bring about a slight decrease.

TABLE 12.1
Density, hardness and clumping test results.

| Material/ | | Hardness | | | Clumping |
|---|---|---|---|---|---|
| Parameter | Density | # Soft | # Med | # Very Hard | Strength |
| Sample A | 519.0 kg/m³ | 5 | 4 | 1 | 17.10 g clump |
| (Gellan & | 36.0 lbs/ft³ | | | | 93.1% |
| Syrup) | | | | | |
| Sample B | 506.7 kg/m³ | 6 | 3 | 1 | 19.00 g clump |
| (Gellan/ | 35.2 lbs/ft³ | | | | 90.5% |
| MCC) | | | | | |

Trial 13—Gellan Gum Binder with a Powdered Corn Syrup and CMC Shell

The purpose of this trial was to confirm the effect of reducing the amount of powdered corn syrup in the core and increasing it in the shell with Gellan and CMC as shell binder and Gellan and extra powdered corn syrup as a second shell binder. The test was also conducted with these shell additions shell to find a solution to granule hardness. The precise core recipe amounts were missed during core sample preparation in Part A, which may have influenced the final granules sizes that were somewhat oversize.

### Recipe for Part A:

The water citric acid mixture that was previously made was used again and the base material was 38 grams of citric acid in 225.6 grams of water and to this mixture ˜1.72 grams of pre-gelatinized corn starch was added to increase the viscosity. This mixture represented a pre-gelatinized starch addition rate of 6.5 grams/Litre of final acid water. Only a portion of this 264.6 grams of liquid was used to form the core granules.
29.5 grams of First Source DE, 29.5 grams of Second Source DE, 4 grams of corn starch, 2.7 grams of powdered corn syrup and 41 grams of the viscous acid water were mixed together to form a dust free damp powder. Once homogenous 16.07 grams of tap water was added to bring the mixture to the right consistency for granule formation.

### Recipe for Part B:

Bentonite mixed with shell coating binder to coat the exterior of the produced smaller granules. The amount of shell material supplied was 80% of the wet mass of the core material. The shell material was 80% bentonite, 10% Gellan Gum and 10% CMC by mass for one sample and in a second sample the mixture was 70% bentonite, 10% Gellan Gum binder and 20% powdered corn syrup binder for a hardener. Final mixes were:
   For sample A, 50 grams of core granules were formed and 32 g of bentonite plus 4 grams of Gellan Gum mixed with 4 grams of CMC along with 24.8 grams of tap water were added as the coating.
   For sample B, 50 grams of core granules were formed and 32 g of bentonite plus 4 grams of Gellan Gum mixed with 8 grams of powdered corn syrup along with 15.75 grams of tap water were added as the coating.

Results. Part A. The core granules generated and formed in the mixing bowl and on the shaken screen when the moisture threshold appeared ideal. At the final misting of water granules began to form but they quickly congealed into particles moderately larger than the target size, although some target size material was produced. Part B. The core granules coated easily but produced over-sized final granules for drying. Once dried at ˜102° C. it was obvious some granules were all near target size but the bulk was oversized. Sample B almost appeared to dry bigger. Table 13.1 shows the results for the density, hardness and clumping strength. In this trial the hardness produced was the hardest to date. Although the granules were oversized which appears to influence hardness a series of smaller granules from the samples was isolated for hardness checking and the results were very good. The clumping strength was very good for the Gellan Gum alone and it even held the large granules together but the Gellan CMC completely failed.

TABLE 13.1
Density, hardness and clumping test results.

| Material/ | | Hardness | | | Clumping |
|---|---|---|---|---|---|
| Parameter | Density | # Soft | # Med | # Very Hard | Strength |
| Sample A | 562.2 kg/m³ | 0 | 0 | 10 | No Clump |
| (Gellan & | 39.0 lbs/ft³ | | | | 0.0% |
| CMC) | | | | | |
| Sample B | 606.8 kg/m³ | 0 | 1 | 9 | 20.37 g clump |
| (Gellan/ | 42.1 lbs/ft³ | | | | 93.8% |
| Syrup) | | | | | |

Trial 14—Gellan Gum Binder with a Powdered Corn Syrup and Lignosulfonate Shell

The purpose of this trial was to confirm the effect of reducing the amount of powdered corn syrup in the core and increasing binders in the shell, with Gellan and Lignosulfonate as one shell binder and Gellan and extra powdered corn syrup as a second shell binder.

### Recipe for Part A:

The water citric acid mixture that was previously made was used again (mistakenly the higher strength citric formulation was used) and the base material was 65.5 grams of citric acid in 233.3 grams of water and to this mixture 1.5 grams of pre-gelatinized corn starch was added to increase the viscosity. This mixture represented a pre-gelatinized starch addition rate of 5.0 grams/Litre of final acid water. Only a portion of this 303 grams of liquid was used to form the core granules.
29.5 grams of First Source DE, 29.5 grams of Second Source DE, 4 grams of corn starch, 2.5 grams of powdered corn syrup and 41 grams of the viscous acid water were mixed together to form a dust free damp powder. Once homogenous 14.52 grams of tap water was added to bring the mixture to the right consistency for granule formation.

### Recipe for Part B:

Bentonite mixed with shell coating binder to coat the exterior of the produced smaller granules. The amount of shell material supplied was 80% of the wet mass of the core material. The shell material was 80% bentonite, 10% Gellan Gum and 10% lignosulfonate by mass for one sample and in a second sample the mixture was 70% bentonite, 10% Gellan Gum binder and 20% powdered corn syrup binder MCC for a hardener. Final mixes were:
   For sample A, 50 grams of core granules were formed and 32 g of bentonite plus 4 grams of Gellan Gum mixed with 4 grams of lignosulfonate along with 26.03 grams of tap water were added as the coating.
   For sample B, 50 grams of core granules were formed and 32 g of bentonite plus 4 grams of Gellan Gum mixed with 8 grams of powdered corn syrup along with 16.16 grams of tap water were added as the coating.

Results. Part A. The core granules generated and formed in the mixing bowl and on the shaken screen when the moisture threshold appeared ideal. In general smaller granules formed than desirable, but a meaningful amount of target sized granules were made with few oversized. Part B. The core granules coated easily but overall produced smaller granules than desired, but a meaningful amount of target sized granules were made along with a few oversized granules. Table 14.1 shows the results for the density, hardness and clumping strength. In this trial the hardness produced was for Sample B was adequate despite the small granule size and clumping was quite good. However the lignosulfonate treatment in sample A yielded soft granules that would not clump.

TABLE 14.1
Density, hardness and clumping test results.

| Material/ | | Hardness | | | Clumping |
|---|---|---|---|---|---|
| Parameter | Density | # Soft | # Med | # Very Hard | Strength |
| Sample A | 497.0 kg/m³ | 9 | 1 | 0 | no clump |
| (Gellan & | 34.5 lbs/ft³ | | | | 0.0% |
| Ligno) | | | | | |
| Sample B | 531.7 kg/m³ | 1 | 3 | 6 | 16.72 g clump |
| (Gellan/ | 36.9 lbs/ft³ | | | | 94.6% |
| Syrup) | | | | | |

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

All patents, patent applications and printed publications referred to in this disclosure are incorporated by reference in their entireties.

Certain embodiments may have the following aspects:
A. A composite particle comprising:
   an absorbent core comprising an absorbent material, a cohesive binder, and a core hardening binder; and
   an outer clumping coating comprising a coating material, a clumping binder and a coating hardening binder.
B. A composite particle as defined in the preceding aspect, wherein the absorbent core further comprises an odour-neutralizing agent.
C. A composite particle as defined in any one of the preceding aspects, wherein the absorbent material comprises aluminosilicates, hydrous aluminum silicates, phyllosilicates, tectosilicates, nesosilicates/orthosilicates, or siliceous rocks.
D. A composite particle as defined in any one of the preceding aspects, wherein the absorbent material comprises clay, volcanic clays, zeolites, bentonite, diatomaceous earth, montmorillonite, Fuller's earth, silicates, attapulgite, smectites, kaolinite, hormites, sepiolite, halloysite, metakaolin, hectorite, vermiculite, fly ash, muscovite, biotite, chlorite, hallyosite, illite, quartz, feldspar, micas, andalusite, kyanite, sillimanite, leucite, faujasite, analcime, nepheline, prehnite, pumice, gypsum, alumina, perlite, calcite, or dolomite.
E. A composite particle as defined in any one of the preceding aspects, wherein the absorbent material comprises diatomaceous earth.
F. A composite particle as defined in any one of the preceding aspects, wherein the absorbent material comprises diatomaceous earth and bentonite.
G. A composite particle as defined in any one of the preceding aspects, wherein the absorbent material comprises zeolite.
H. A composite particle as defined in any one of the preceding aspects, wherein the cohesive binder comprises a thickener.
I. A composite particle as defined in any one of the preceding aspects, wherein the cohesive binder comprises a carbohydrate binder.
J. A composite particle as defined in any one of the preceding aspects, wherein the cohesive binder comprises a polysaccharide binder.
K. A composite particle as defined in any one of the preceding aspects, wherein the cohesive binder comprises a starch.
L. A composite particle as defined in any one of the preceding aspects, wherein the cohesive binder comprises a cellulose.
M. A composite particle as defined in any one of the preceding aspects, wherein the cohesive binder comprises a natural binder.
N. A composite particle as defined in any one of the preceding aspects, wherein the cohesive binder comprises cornstarch, pea starch, or microcrystalline cellulose (MCC).
O. A composite particle as defined in any one of the preceding aspects, wherein at least a portion of the cohesive binder comprises pre-gelatinized cornstarch.
P. A composite particle as defined in any one of the preceding aspects, wherein the core hardening binder comprises a hardening agent.
Q. A composite particle as defined in any one of the preceding aspects, wherein the core hardening binder comprises corn syrup or carboxymethyl cellulose (CMC).
R. A composite particle as defined in the preceding aspect, wherein the corn syrup comprises powdered corn syrup.
S. A composite particle as defined in any one of the preceding aspects, wherein the coating material comprises aluminosilicates, hydrous aluminum silicates, phyllosilicates, tectosilicates, nesosilicates/orthosilicates, or siliceous rocks.
T. A composite particle as defined in any one of the preceding aspects, wherein the coating material comprises clay, volcanic clays, zeolites, bentonite, diatomaceous earth, montmorillonite, Fuller's earth, silicates, attapulgite, smectites, kaolinite, hormites, sepiolite, halloysite, metakaolin, hectorite, vermiculite, fly ash, muscovite, biotite, chlorite, hallyosite, illite, quartz, feldspar, micas, andalusite, kyanite, sillimanite, leucite, faujasite, analcime, nepheline, prehnite, pumice, gypsum, alumina, perlite, calcite, or dolomite.
U. A composite particle as defined in any one of the preceding aspects, wherein the coating material comprises bentonite.
V. A composite particle as defined in any one of the preceding aspects, wherein the coating material comprises bentonite and diatomaceous earth.
W. A composite particle as defined in any one of the preceding aspects, wherein the coating material comprises bentonite fines.
X. A composite particle as defined in any one of the preceding aspects, wherein the clumping binder comprises a gum.
Y. A composite particle as defined in any one of the preceding aspects, wherein the clumping binder comprises a high temperature resistant gum.
Z. A composite particle as defined in any one of the preceding aspects, wherein the clumping binder comprises a natural gum.
AA. A composite particle as defined in any one of the preceding aspects, wherein the gum comprises gellan gum, xanthan gum, guar gum, carob bean gum, Arabic gum, cellulose gum, carrageenan, tara gum, or konjac gum.
BB. A composite particle as defined in any one of the preceding aspects, wherein the clumping binder comprises gellan gum.
CC. A composite particle as defined in any one of the preceding aspects, wherein the clumping binder comprises a binder that exhibits adhesive qualities after formulation to facilitate clumping of the composite particles upon exposure to moisture.
DD. A composite particle as defined in any one of the preceding aspects, wherein the clumping binder comprises cornstarch.
EE. A composite particle as defined in any one of the preceding aspects, wherein the coating hardening binder comprises a hardening agent.
FF. A composite particle as defined in any one of the preceding aspects, wherein the coating hardening binder comprises corn syrup, copovidone, or carboxymethylcellulose (CMC).
GG. A composite particle as defined in the preceding aspect, wherein the corn syrup comprises powdered corn syrup.
GH. A composite particle as defined in any one of the preceding aspects, wherein the outer clumping coating comprises a carbohydrate binder, optionally a polysaccharide binder, optionally caboxymethylcellulose (CMC), a starch, a modified starch, a dextrin or a modified dextrin, wherein the coating is made by combining the coating material with an aqueous solution of the carbohydrate binder and drying the resultant material at a temperature of between about 90° C. and about 115° C. for a suitable period, for example between about 4 hours and about 24 hours, and the dried material is then size reduced to provide the outer clumping coating.
HH. A composite particle as defined in any one of the preceding aspects, wherein the odour-neutralizing agent comprises an acid.
II. A composite particle as defined in any one of the preceding aspects, wherein the odour-neutralizing agent comprises an organic acid.
JJ. A composite particle as defined in any one of the preceding aspects, wherein the odour-neutralizing agent comprises an organic acid having a pH at a concentration of 0.1 N of between about 2.0 and about 3.0.
KK. A composite particle as defined in any one of the preceding aspects, wherein the odour-neutralizing agent comprises citric acid, tartaric acid, malic acid, formic acid, lactic acid, succinic acid, acetic acid, propionic acid, or a mixture thereof.
LL. A composite particle as defined in any one of the preceding aspects, wherein the odour-neutralizing agent comprises citric acid.
MM. A composite particle comprising: an absorbent core; and an outer clumping coating comprising a coating material and a binder.
NN. A composite particle as defined in any one of the preceding claims, wherein: the absorbent material comprises aluminosilicates, hydrous aluminum silicates, phyllosilicates, tectosilicates, nesosilicates/orthosilicates, or siliceous rocks; optionally the absorbent material comprises clay, volcanic clays, zeolites, bentonite, diatomaceous earth, montmorillonite, Fuller's earth, silicates, attapulgite, smectites, kaolinite, hormites, sepiolite, halloysite, metakaolin, hectorite, vermiculite, fly ash, muscovite, biotite, chlorite, hallyosite, illite, quartz, feldspar, micas, andalusite, kyanite, sillimanite, leucite, faujasite, analcime, nepheline, prehnite, pumice, gypsum, alumina, perlite, calcite, or dolomite; optionally the absorbent material comprises diatomaceous earth and bentonite; optionally the absorbent material comprises zeolite.
OO. A composite particle as defined in any one of the preceding claims, wherein the absorbent material comprises diatomaceous earth.
PP. A composite particle as defined in any one of the preceding claims, wherein the coating material comprises aluminosilicates, hydrous aluminum silicates, phyllosilicates, tectosilicates, nesosilicates/orthosilicates, or siliceous rocks; optionally the coating material comprises clay, volcanic clays, zeolites, bentonite, diatomaceous earth, montmorillonite, Fuller's earth, silicates, attapulgite, smectites, kaolinite, hormites, sepiolite, halloysite, metakaolin, hectorite, vermiculite, fly ash, muscovite, biotite, chlorite, hallyosite, illite, quartz, feldspar, micas, andalusite, kyanite, sillimanite, leucite, faujasite, analcime, nepheline, prehnite, pumice, gypsum, alumina, perlite, calcite, or dolomite; optionally the coating material comprises bentonite and diatomaceous earth.
QQ. A composite particle as defined in any one of the preceding claims, wherein the coating material comprises bentonite, optionally bentonite fines.
RR. A composite particle as defined in any one of the preceding claims, wherein the binder comprises a binder that exhibits adhesive qualities after formulation to facilitate clumping of the composite particles upon exposure to moisture.
SS. A composite particle as defined in any one of the preceding claims, wherein the binder comprises a carbohydrate binder, optionally wherein the carbohydrate binder is carboxymethylcellulose (CMC), a starch, a modified starch, a dextrin or a modified dextrin.

1. A method of making a composite particle comprising:
forming an absorbent core from an absorbent material;
forming a coating composition by combining a coating material and a binder and heat treating the combined coating material and binder; and
coating the coating composition on the absorbent core.

2. The method as defined in claim 1, wherein the step of forming an absorbent core comprises using a compaction method to produce the absorbent core from the absorbent material, optionally using a roller compactor.

3. The method as defined in claim 1, wherein:
the absorbent material comprises aluminosilicates, hydrous aluminum silicates, phyllosilicates, tectosilicates, nesosilicates/orthosilicates, or siliceous rocks;
optionally the absorbent material comprises clay, volcanic clays, zeolites, bentonite, diatomaceous earth, montmorillonite, Fuller's earth, silicates, attapulgite, smectites, kaolinite, hormites, sepiolite, halloysite, metakaolin, hectorite, vermiculite, fly ash, muscovite, biotite, chlorite, hallyosite, illite, quartz, feldspar, micas, andalusite, kyanite, sillimanite, leucite, faujasite, analcime, nepheline, prehnite, pumice, gypsum, alumina, perlite, calcite, or dolomite;
optionally the absorbent material comprises diatomaceous earth and bentonite;
optionally the absorbent material comprises zeolite.

4. The method as defined in claim 3, wherein the absorbent material comprises diatomaceous earth, optionally diatomaceous earth fines.

5. The method as defined in claim 1, wherein the absorbent material comprises a moisture content of between about 8% and about 12% by weight prior to being supplied to the roller compactor.

6. The method as defined in claim 1, comprising drying the absorbent core after the step of forming the absorbent core.

7. A method as defined in claim 1, wherein the absorbent core has a particle diameter of between about 1.2 mm and about 1.7 mm.

8. A method as defined in claim 1, wherein the step of forming a coating composition comprises forming an aqueous solution of the binder, optionally wherein the step of forming an aqueous solution of the binder comprises dissolving a polysaccharide binder in warm water, optionally using a shear mixer.

9. A method as defined in claim 8, wherein the step of combining the coating material and the binder comprises mixing the coating material with the aqueous solution of the binder.

10. A method as defined in claim 1, wherein the binder comprises a carbohydrate binder, optionally wherein the carbohydrate binder comprises carboxymethylcellulose (CMC), a starch, a modified starch, a dextrin or a modified dextrin.

11. A method as defined in claim 1, wherein:
the coating material comprises aluminosilicates, hydrous aluminum silicates, phyllosilicates, tectosilicates, nesosilicates/orthosilicates, or siliceous rocks;
optionally the coating material comprises clay, volcanic clays, zeolites, bentonite, diatomaceous earth, montmorillonite, Fuller's earth, silicates, attapulgite, smectites, kaolinite, hormites, sepiolite, halloysite, metakaolin, hectorite, vermiculite, fly ash, muscovite, biotite, chlorite, hallyosite, illite, quartz, feldspar, micas, andalusite, kyanite, sillimanite, leucite, faujasite, analcime, nepheline, prehnite, pumice, gypsum, alumina, perlite, calcite, or dolomite; or
optionally the coating material comprises bentonite and diatomaceous earth.

12. A method as defined in claim 1, wherein the coating material comprises bentonite, optionally bentonite fines.

13. A method as defined in claim 1, wherein heat treating the combined coating material and binder comprises drying the combined material at a temperature of between about 90° C. and about 115° C., optionally wherein the drying is conducted for a period of between about 4 and about 24 hours.

14. A method as defined in claim 1, wherein forming the coating composition comprises forming a coating powder by size reducing the combined coating material and binder after said heat treating.

15. A method as defined in claim 1, wherein coating the coating composition on the absorbent core comprises using a seasoning drum or a coating drum.

16. A method as defined in claim 15, wherein coating the coating composition on the absorbent core comprises adding about 20% to about 30% of water relative to a total weight of the final composite particles after coating.

17. A method as defined in claim 1, wherein the composite particles have a diameter of between about 1.5 to about 2.0 mm.

18. A method as defined in claim 1, wherein the composite particle produced by the method comprises on a dry matter basis:
between about 35% to about 70% by weight of the absorbent material;
between about 15% to about 60% by weight of the coating material; and
between about 5% to about 15% of the binder;
optionally wherein the composite particle produced by the method comprises on a dry matter basis:
between about 50% to about 60% by weight of the absorbent material;
between about 30% to about 40% by weight of the coating material; and
between about 8% to about 12% of the binder.

19. A method as defined in claim 1, wherein a ratio of the binder to the coating material by weight is in the range of about 1:5 to about 1:10.

20. A composite particle made by the method as defined in claim 1.
